(19) United States
(12) Patent Application Publication
(10) Pub. No.: US 2011/0292997 A1
(43) Pub. Date: Dec. 1, 2011

(54) CONTROL OF VIDEO ENCODING BASED ON IMAGE CAPTURE PARAMETERS

(75) Inventors: CHEOLHONG AN, San Diego, CA (US); Liang Liang, San Diego, CA (US); Szepo Robert Hung, San Diego, CA (US)

(73) Assignee: QUALCOMM Incorporated, San Diego, CA (US)

(21) Appl. No.: 13/114,844

(22) Filed: May 24, 2011

Related U.S. Application Data
(63) Continuation-in-part of application No. 12/774,491, filed on May 5, 2010.
(60) Provisional application No. 61/347,702, filed on May 24, 2010.
(60) Provisional application No. 61/258,913, filed on Nov. 6, 2009.

(51) Int. Cl. H04N 7/26

(52) U.S. Cl. 375/240.03; 375/240.02; 375/E07.139; 375/E07.126; 375/E07.125

(57) ABSTRACT

This disclosure describes techniques for improving functionalities of a back-end device, e.g., a video encoder, using parameters detected and estimated by a front-end device, e.g., a video camera. The techniques may involve estimating a blurriness level associated with frames captured during a refocusing process. Based on the estimated blurriness level, the quantization parameter (QP) used to encode blurry frames is adjusted either in the video camera or in the video encoder. The video encoder uses the adjusted QP to encode the blurry frames. The video encoder also uses the blurriness level estimate to adjust encoding algorithms by simplifying motion estimation and compensation in the blurry frames.

This application claims the benefit of U.S. Provisional Application No. 61/347,702, filed on May 24, 2010, and is a continuation-in-part of U.S. patent application Ser. No. 12/774,491, filed on May 5, 2010, which claims the benefit of U.S. Provisional Application No. 61/258,913, filed on Nov. 6, 2009, the entire content of each being incorporated herein by reference.

### TECHNICAL FIELD

The disclosure relates to video coding.

### BACKGROUND

Digital multimedia capabilities can be incorporated into a wide range of devices, including digital televisions, digital direct broadcast systems, wireless communication devices, wireless broadcast systems, personal digital assistants (PDAs), laptop or desktop computers, digital cameras, digital recording devices, video gaming devices, video game consoles, cellular or satellite radio telephones, digital media players, and the like. Digital multimedia devices may implement video coding techniques, such as MPEG-2, ITU-H.263, MPEG-4, or ITU-H.264/MPEG-4 Part 10, Advanced Video Coding (AVC), or the High Efficiency Video Coding (HEVC) standard presently under development by Joint Collaborative Team on Video Coding (JCT-VC), to transmit and receive or store and retrieve digital video data more efficiently.

Video encoding techniques may perform video compression via spatial and temporal prediction to reduce or remove redundancy inherent in video sequences. A video capture device, e.g., video camera, may capture video and send it to video encoder for encoding. The video encoder processes the captured video, encodes the processed video, and transmits the encoded video data for storage or transmission. In either case, the encoded video data is encoded to reproduce the video for display. The available bandwidth for storing or transmitting the video is often limited, and is affected by factors such as the video encoding data rate.

Several factors contribute to the video encoding data rate. Therefore, when designing video encoders, one of the concerns is improving the video encoding data rate. Generally, improvements are implemented in the video encoder and often add extra computation complexity to the video encoder, which can offset some of the benefits of an improved video encoding data rate.

### SUMMARY

This disclosure describes techniques for controlling video coding based, at least in part, on one or more parameters of a video capture device. The techniques may be performed in a video capture device, such as a camera, and/or a video coding device, such as a video encoder. The video capture device may sense, measure or generate one or more parameters, which may be utilized to make determinations that can be used to control video coding parameters. The parameters obtained by the video capture device may be utilized to estimate blurriness associated with captured frames. Parameters used in video coding may be modified based on the estimated blurriness.

In one example, this disclosure describes a method comprising estimating, in a video capture module, a blurriness level of a frame of video data captured during a refocusing process of the video capture module, and encoding, in a video encoder, the frame based at least in part on the estimated blurriness level of the frame.

In another example, this disclosure describes a system comprising means for estimating, in a video capture module, a blurriness level of a frame of video data captured during a refocusing process of the video capture module, and means for encoding, in a video encoder, the frame based at least in part on the estimated blurriness level of the frame.

In another example, this disclosure describes a system comprising a video capture module to estimate a blurriness level of a frame of video data captured during a refocusing process of the video capture module, and a video encoder to encode the frame based at least in part on the estimated blurriness level of the frame.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a non-transitory, computer-readable storage medium and loaded and executed in the processor.

Accordingly, this disclosure also contemplates a computer-readable medium comprising instructions for causing a programmable processor to estimate, in a video capture module, a blurriness level of a frame of video data captured during a refocusing process of the video capture module, and encode, in a video encoder, the frame based at least in part on the estimated blurriness level of the frame.

In another example, this disclosure describes a method comprising estimating a blurriness level of a frame of video data based on a type of motion detected in the frame, and encoding, in a video encoder, the frame based at least in part on the estimated blurriness level of the frame.

In another example, this disclosure describes an apparatus comprising a blurriness unit to estimate a blurriness level of a frame of video data based on a type of motion detected in the frame, and a video encoder to encode the frame based at least in part on the estimated blurriness level of the frame.

In another example, this disclosure describes a system comprising a means for estimating a blurriness level of a frame of video data based on a type of motion detected in the frame, and means for encoding the frame based at least in part on the estimated blurriness level of the frame.

In another example, this disclosure also contemplates a computer-readable medium comprising instructions for causing a programmable processor to estimate a blurriness level of a frame of video data based on a type of motion detected in the frame, and encode, in a video encoder, the frame based at least in part on the estimated blurriness level of the frame.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating an exemplary video capture device and video encoder system that may implement techniques of this disclosure.

FIG. 2 is a block diagram illustrating another exemplary video capture device and video encoder system that may implement techniques of this disclosure.

FIG. 3 is a flow diagram illustrating video capturing functions resulting in blurriness in captured frames.

FIGS. 4A-4F illustrate example video capture device functions that cause blurriness in frames captured by the video capture device.

FIG. 5 is a block diagram illustrating one example of a video encoding system that implements the techniques of this disclosure.

FIG. 6 is a block diagram illustrating an example of a rate control block that implements the techniques of this disclosure.

FIG. 7 is a diagram illustrating performance of an example continuous auto-focus refocusing process by a video capture device.

FIGS. 8A-8C are graphical representations illustrating auto-focus refocusing process associated with face detection.

FIGS. 9A-9B are graphical representations illustrating auto-focus refocusing process associated with zooming.

FIG. 10 is a diagram illustration exemplary block partition sizes for motion estimation during encoding.

FIG. 11 illustrates one example of estimating motion blurriness, in accordance with techniques of this disclosure.

FIG. 12 illustrates another example of estimating motion blurriness, in accordance with techniques of this disclosure.

FIG. 13A illustrates an example of a QP decision using blurriness levels.

FIG. 13B illustrates example estimated blurriness levels used to make a QP decision according to FIG. 13A.

FIG. 13C illustrates an example of a QP decision using a lookup table.

FIG. 14 illustrates an example system with two video capture device modules that implements the techniques of this disclosure.

FIGS. 15A-15C are flow diagrams illustrating video encoding using an estimate of blurriness levels in captured frames in accordance with example techniques of this disclosure.

FIG. 16 is a flow diagram illustrating video encoding using an estimate of blurriness levels to simplify encoding algorithms in accordance with example techniques of this disclosure.

### DETAILED DESCRIPTION

During a real-time video recording, blurriness in a video frame can be caused by several factors. For example, panning or motion of the video capture device, motion of an object in an image being captured by the video capture device, or zooming in or out of a scene being captured by the video capture device, e.g., a video camera, may cause blurriness as the camera or object moves too quickly to focus. Blurriness may also occur during the refocusing phase in a system with continuous auto-focus (CAF) or auto-focus (AF) or during refocus when manual focusing is used.

In the example of video capture devices that use CAF, the lens position may be adjusted continuously, e.g., on a frame-by-frame basis, to achieve the best focus performance. When an object of interest has changed or moved during video recording, the video capture device refocuses by finding the new focal plane of a new object of interest. For example, during a panning motion of the video capture device, CAF may occur when the video capture device is no longer in motion at the end of the panning to refocus on the new scene captured in the frame. In another example, during motion that is detected by a motion sensor, a face or another object may be detected in the frame, which may trigger the AF process. In another example, the AF process may be triggered to refocus following zooming in or out by the camera. Blurriness occurs during this refocus process, and the frames the device captures until the new focal plane is found may be blurry during the refocusing process until refocus is achieved. Additionally, blurriness can occur in frames during other types of motion, such as, for example, movement of objects within the frame or during portions of the panning motion process when refocusing does not occur (e.g., while the camera is moving). Blurriness occurs in these types of frames, where the blurriness is not caused by the refocusing process.

Blur caused by motion may occur in captured video frames because of movement of the video capture device, e.g., camera, hand jitter, or as a result of object movement while capturing the video frames. Camera movement and object movement visually result in similar motion blur effect. However, camera movement introduces global motion blur, whereas a moving object introduces local motion blur. In some video capture devices, special camera modes (e.g., hand jitter reduction and night capture mode) may be used to reduce motion blur by controlling exposure time. Techniques of this disclosure, described below, may be used in video capture devices whether or not such devices utilize any of these special camera modes, because in some examples the techniques may be used to estimate blurriness using exposure time.

Video encoders perform video data rate control by performing computations to make determinations regarding the content of frames. These computations generally add computational complexity to the video encoder. Techniques of this disclosure may include performing functions in a video capture device and/or a video encoder based on parameters determined and/or measured by the video capture device. In one aspect of this disclosure, the video encoder may reduce additional computational complexity by using information the video encoder obtains from the video capture device that records the video frames.

This disclosure describes techniques for controlling video coding based, at least in part, on one or more parameters of a video capture device. In some examples, a video encoder may control video coding based on an estimate of blurriness levels in frames in which blurriness is detected. Blurriness in frames may be detected when functions, which typically result in blurriness, are performed by the video capture device. The blurriness of frames in which blurriness is detected may then be estimated using one or more parameters of the video capture device. In one example, certain functions may result in refocus during video capture in a video capture device that supports a continuous auto-focus (CAF) process, which may result in blurriness of frames captured during the CAF process. In other examples, motion during the video capture, either by panning, zooming, movement of objects within the frame, or other types of motion may result in blurriness of the frame because of the motion and refocusing auto-focus (AF).

In a video system, such as a video encoding system, bandwidth limits may be a concern, and may be affected by parameters such as, for example, video encoding data rate. In one example, techniques in accordance with this disclosure may adjust one or more aspects of a video coding process, such as video encoding data rate, based on characteristics of video frames captured by the video capture device. In one example, bits may be allocated more efficiently in encoding video frames based on the estimated blurriness level of the frames, thus optimizing the video encoding data rate.

In one example, a video capture device may detect blurriness in captured video frames based on the performance of certain functions in the video capture device that typically cause blurriness (e.g., motion, zooming, panning, and the like). The detected blurriness may then be estimated using parameters determined and/or measured by the video capture device. The blurriness may be estimated in the video capture device or the video encoder. In some example, a video system comprising the video capture device and a video encoder may provide the capability of estimating the blurriness in either the video capture device or the video encoder. In one example, the video capture device and the video encoder may be part of one device. In such an example, at least a portion of the functionalities of each of the video capture device and the video encoder may be performed by one processor, which may also perform such operations as blurriness estimation.

In one example, a video capture device may estimate an amount of blurriness in video frames captured during an event that causes blurriness, e.g., during a refocusing phase of a CAF process, during a panning motion of the device, during zooming in or out, or during other motion that causes blurriness in the frames. The video capture device may send to the video encoder the estimate of the amount of blurriness in a video frame. In another example, the video capture device may send, to the video encoder, one or more parameters associated with an event that causes blurriness, and the video encoder may estimate an amount of blurriness in the corresponding video frames based on the parameters.

Based on the amount of blurriness in a video frame, the video encoder may allocate less data rate, i.e., less coding bits, to encode frames with an amount of blurriness above a certain threshold, without having to evaluate the blurriness within the video encoder. Rather, in some examples, the encoder may rely on a blurriness parameter already determined by the video capture device. In other examples, the encoder may estimate blurriness based on oine or more parameters associated with an event that causes blurriness. When blurriness is detected, the video encoder may allocate less data rate to encode blurry frames, because blurry frames generally have a lower visual quality that is not affected, or less affected, by using lower data rates. When the content of a video frame becomes blurry, in accordance with one aspect of this disclosure, a video encoder may allocate less data rate, i.e., coding bits, to encode a blurry frame, thereby reducing bandwidth consumption while maintaining an acceptable overall visual quality, given the blurriness.

In one aspect of the disclosure, the quantization parameter (QP) may be adjusted based on the blurriness estimate, and may vary based on the amount of blur in a frame. In another aspect of the disclosure, the video encoder may encode frames using different size block partitions for prediction coding and motion compensation. In another aspect of the disclosure, the video encoder need not implement algorithms for determining whether frames are blurry and the amount of blurriness in them, as these are decided by the video capture device.

Using the techniques of this disclosure, simplified video encoding algorithms may reduce the video encoder's computational complexity and a lower data rate may reduce bandwidth used by the video encoder. The blurriness estimate may be reported to the video encoder from the video capture device. The video encoder may, in turn, determine that a particular frame is blurry without expending encoder resources to detect blurriness, which may be a computationally-intensive operation when done by the video encoder. Instead, the video encoder may rely on the blurriness estimate evaluated by video capture device.

In one example, the techniques of this disclosure may be implemented by a rate control (RC) algorithm performed by a video encoder. The RC algorithm may utilize motion blur estimation in captured video frames to improve perceptual quality. The algorithm may estimate blurriness of captured video frames using parameters such as a global motion vector (MV), encoding frame rate, and exposure time. For a given estimated blurriness of frames, applying the RC algorithm, the video encoder may reallocate coding bits between blurry frames and sharp frames. In particular, the video encoder may allocate fewer coding bits to blurry frames and more coding bits to non-blurry frames, e.g., by adjusting the quantization parameter for each frame to control the degree of quantization applied to residual transform coefficints produced by predictive coding. In this manner, savings in coding blurry frames may be utilized to improve coding of other frames.

Aspects of this disclosure may be utilized in any of a variety of recording devices, which may be a stand-alone recording device or a portion of a system. For purposes of this discussion, a video camera is used as an exemplary video capture device.

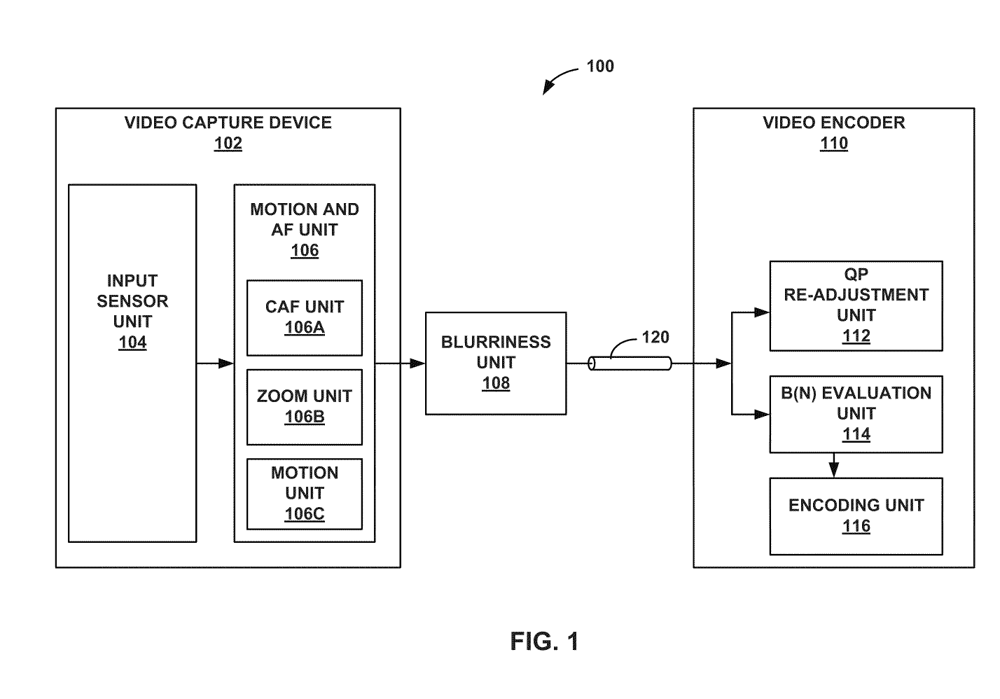

FIG. 1 is a block diagram illustrating an exemplary video capture device and video encoder system 100 that may implement techniques of this disclosure. As shown in FIG. 1, system 100 includes a video capture device 102, e.g., video camera that captures and sends a video stream to video encoder 110 via link 120. System 100 may also include blurriness unit 108, which may be part of video capture device 102 or video encoder 110. Therefore, in the example of FIG. 1, blurriness unit 108 may be depicted separately from either device. Video capture device 102 and video encoder 110 may comprise any of a wide range of devices, including mobile devices. In some examples, video capture device 102 and video encoder 110 comprise wireless communication devices, such as wireless handsets, personal digital assistants (PDAs), mobile media players, cameras, or any devices that can capture and encode video data. In some examples, video capture device 102 and video encoder 110 may be contained in the same enclosure as part of the same system. In other examples, video capture device 102 and video encoder 110 may reside in two or more different devices, and may be part of two or more different systems. If video capture device 102 and video encoder 110 reside in two or more different devices, link 120 may be a wired or wireless link.

In the example of FIG. 1, video capture device 102 may include input sensor unit 104, and motion and AF unit 106. Motion and AF unit 106 may include several functionality units associated with video capturing such as, for example, CAF unit 106A, zoom unit 106B, and motion unit 106C. Video encoder 110 may include QP re-adjustment unit 112, frame blurriness evaluation unit 114, and encoding unit 116. In accordance with this disclosure, video capture device 102 may be configured to obtain parameters associated with one or more functions, e.g., zooming, panning, motion detection, which may be further processed by motion and AF unit 106 and provided to blurriness unit 108. Blurriness unit 108 may estimate the level of blurriness of frames using the camera parameters and send the blurriness estimate to video encoder 110. Video encoder 110 may use blurriness information to determine appropriate video encoding data rate and/or simplify video encoding algorithms.

Input sensor unit 104 may include input sensors associated with video capture device 102 and algorithms that determine one or more parameters associated with captured frames based on the frame images sensed by the input sensors. Input sensor unit 104 of video capture device 102 may sense frame image contents for capturing. Input sensor unit 104 may include a camera lens coupled to a sensor such as, for example, a charge coupled device (CCD) array or another image sensing device that receives light via the camera lens and generates image data in response to the received image. Input sensor unit 104 may include the capability to detect changes in conditions to determine the appropriate function for capturing the corresponding frames. Based on the function performed by input sensor 104, motion and AF unit 106 may determine the appropriate functionality, e.g., whether to apply auto focus (AF) and type of AF to apply. For example, during panning motion, CAF may be applied, while during zooming an AF process that utilizes zooming factor information may be applied. Motion and AF unit 106 may detect blurriness in a frame based on the associated function and send an indication of blurriness detection with the parameters corresponding to the function, e.g., zoom factor, lens positions, other lens and sensor parameters, and so forth.

In one example, during a panning motion, a user moves video capture device 102 to capture a different object or scene. In this example, the motion of video capture device 102 may be determined using input sensor unit 104, which may be equipped with sensors capable of detecting panning motion of the device. During a panning motion, frames captured while video capture device 102 is in motion may not require refocusing, as the scene being captured changes rapidly. When video capture device 102 stops the motion, the refocusing process may begin while capturing frames. Refocusing in this example may be performed using CAF until focus is achieved. Frames captured during the panning motion and until focus is achieved after the panning motion stops may contain blurriness. Blurriness in frames associated with panning motion may be the result of the motion or the result of the refocusing process. Blurriness resulting from refocusing may be estimated using information associated with lens positions during the refocusing process, which may be provided by input sensor unit 104. Blurriness resulting from the panning motion, when no refocusing is performed may be estimated using motion associated with the device during the panning motion and/or motion of objects within the frame.

Video capture device 102 may utilize a CAF process while recording a video. In a CAF process, the camera lens position may continuously adjust to achieve acceptable focus on objects in the video frames. When a new object of interest comes into the scene being captured by input sensor unit 104, the user moves video capture device 102 to capture a different object or different scene, or an object within a scene moves, input sensor unit 104 may detect the presence of the new object. Input sensor unit 104 may then send a signal to the CAF unit 106A, which analyzes the received signal and determines, based on a focus value of the signal, that a new object was detected in the scene and triggering a refocus process. Refocusing on a new object may involve actions such as, for example, adjusting the lens position until the video capture device achieves a desired focus by analyzing focus values of the signals received from input sensor unit 104, where each signal includes the pixels of a frame. CAF unit 106A may send an indication to blurriness unit 108 indicating that CAF unit 106A is performing the refocus process. Blurriness unit 108 may estimate the blurriness in frames while refocusing is occurring. Blurriness unit 108 may estimate a blurriness B(n) associated with frame n, and send B(n) to video encoder 110.

In another example, when video capture device 102 moves in one direction, approaching an object of interest, the field of view associated with the object may change. However, motion may not be detected the same way panning motion would be detected. For example, if a user moves closer or farther away from an object or objects in the frame, while pointing video capture device 102 in the same direction, the field of view gets smaller or larger, respectively, but the global motion within the frame may add up to zero, because the field of view changes by relatively the same amount in all directions. Therefore, this type of motion may not be detected by estimating global motion. Input sensor unit 104 may include a motion sensor (e.g., an accelerometer or a gyroscope) that can detect this type of motion, and may send the detected information to motion and AF unit 106 to determine the appropriate function based on the type of detected object in the frame. In one example, a face may be detected in the frame as a result of the changed field of view. If a face is detected, AF may be used to focus on the face during the motion, and as a result, frames captured while AF is achieved may be blurry. Focusing on a detected face may be achieved by determining the appropriate lens position using parameters associated with face detection, e.g., the size of the face in the captured frame, size of an average human face, and the distance of the object. Blurriness resulting from refocusing on a detected face may be estimated using the determined lens position at each step until focus is achieved. If no face is detected, refocusing may not be triggered until the motion stops, and blurriness may result in frames captured during the motion. Blurriness resulting from the motion may be estimated using motion associated with the device during the panning motion and/or motion of objects within the frame.

In another example, the user may select to zoom in or out during video capture. When video capture device 102 starts optical zoom, the field of view may change during the zooming process, resulting in refocusing, and blurriness may result in frames captured during zooming. AF may be used to focus during zooming, where the zoom factor is known and may be used to determine the lens position to achieve focus. Zooming information, e.g., the zooming factor, may be also utilized by a blurriness estimation unit to estimate blurriness in the frames captured during the zooming process.

In other examples, other types of motion in the frames being captured may result in blurriness, which may be estimated using motion information based on camera parameters, e.g., global motion vectors, exposure time, and frame rate. In some examples, local motion vector information may also be utilized in estimating blurriness. In situations where video capture device 102 performs focusing, parameters associated with the focusing process may be utilized in estimating blurriness. Additionally, in situations where no focusing is used, motion information obtained by video capture device 102 may be utilized in estimating blurriness. In this manner, blurriness may be estimated using parameters obtained and/or calculated for other functions, and therefore, no additional complex calculations or measurements are needed in this example to estimate blurriness. Estimating the blurriness level in each of these examples will be described in more detail below.

Video encoder 110 may receive the blurriness estimate B(n) for frames with blur, and may utilize the blurriness level in encoding the video frames, without having to perform additional calculations to determine the amount of blur in the frames. In one example, video encoder 110 may utilize the blurriness level for QP readjustment 112. In other words, video encoder 110 may adjust the QP value for encoding a frame based on an estimated level of blurriness for the frame.

The QP regulates the amount of detail preserved in an encoded image. Video encoders perform quantization, e.g., of residual values, during encoding. The residual values may be discrete cosine transform (DCT) coefficient values representing a block of residual values representing residual distortion between an original block to be coded, e.g., a macroblock, and a predictive block, in a reference frame, used to code the block. In one example, when an encoder utilizes a very small QP value for higher quantization, a great amount of image detail is retained. However, using a very small QP value results in a higher encoding data rate. As the QP value increases, the video encoding rate drops, but some of the detail is lost, and the image may become more distorted. In blurry images, details of the images are already distorted, and a video encoder may increase the QP, without affecting the quality of the image. Video encoders may implement algorithms to determine whether a frame is blurry. These algorithms, however, add computational complexity to the video encoder.

In one example, blurriness may be estimated in video capture device 102, and therefore, video encoder 110 may not need to determine whether a frame is blurry. Instead, video encoder 110 may receive an indication that a frame is blurry from the video capture device 102. In one example, video encoder 110 may receive an estimated blurriness level B(n) for a frame n to be encoded, and determine based on that blurriness level whether to increase or decrease the QP. In other words, video encoder 110 may adjust the QP values based on the estimated blurriness level B(n) obtained from video capture device 102. In one example, video encoder 110 may use a larger QP to encode frames with a higher amount of blurriness, and use a smaller QP to encode frames with a lower amount of blurriness. In this manner, video encoder 110 may allocate more coding bits to less blurry frames and less coding bits to more blurry frames. Although larger and smaller QP values are described herein as corresponding to more and less quantization, respectively, the opposite may be the case for some coding techniques, where larger and smaller QP values may correspond to less and more quantization, respectively.

In one example, using the techniques of this disclosure, blurry images may be encoded using a QP value based on the level of blurriness in the image. The higher the blurriness level of an image, the smaller number of bits used to code the image. In one example, the number of bits used to code a blurry frame may be reduced without causing additional distortion, because distortion caused by quantization adjustment may not be as noticeable as it would be in a less blurry frame. In some examples, the coded bits may be reallocated between frames, such that frames with a greater blurriness level may be coded using fewer bits, and sharper frames may be coded using more bits, which may have been saved from coding blurring frames using fewer bits. In this manner, the overall bit rate of the video encoder may not be greatly affected, as the amount of coded bit may remain unchanged overall.

Techniques of this disclosure may determine based on the level of blurriness the maximum amount of quantization that would not cause distortion recognizable by the human visual system. Experimental data may be used to determine based on human perception and the insensitivity of the human visual system to provide the different levels of blurriness in a frame and corresponding quantization, such that the overall distortion of the frame is not perceptibly different from the original frame. In one example, a video encoder may code a frame using 137008 bits, which is considered 100% of the coded bits. Based on the level of blurriness in a frame, a corresponding quantization is determined such that the perception of the distortion in the frame is not easily observable. Experiments may utilize different number of coded bit, less or equal to 137008, and determine the lowest number of bits used at a certain blurriness level where the frame may appear to the average human visual system with the same amount of distortion as when 100% of the coded bits is used. The QP corresponding to the reduced number of bits may then be used as the corresponding QP to the blurriness level.

In another example, video encoder 110 may utilize the blurriness level to simplify the encoding algorithm implemented by video encoder 110. A simplified encoding algorithm may be, for example, an algorithm that uses integer pixel precision, instead of fractional pixel precision, for motion estimation search. Other encoding algorithm simplifications may involve, for example, utilize skip mode, modifying the reference picture list used in motion estimation, and modifying block partition size for prediction code and motion compensation, as explained in more detail below. In image encoding, interpolation is used to approximate pixel color and intensity based on color and intensity values of surrounding pixels, and may be used to improve compression in inter-coding. Inter-coding refers to motion estimation to track movement within adjacent frames, and indicates displacement of blocks within frames relative to corresponding blocks in one or more reference frames. During encoding, the encoder may determine the location of a block within a frame. The level of compression may be improved by searching for blocks at a fractional pixel level using sub-pixel or fractional interpolation. The smaller the fraction, the higher compression the encoder achieves, but the more computationally-intensive the encoding algorithm.

For example, interpolation may be performed to generate fractional or sub pixel values (e.g., half and quarter pixel values), and the encoding algorithm may use different levels of precision based on the content. For more detailed frames or block within frames, the encoding algorithm may utilize a smaller sub-pixel value, e.g., quarter, which would require interpolating pixel values at quarter pixel locations. For less detailed frames or blocks within frames, the encoding algorithm may utilize interpolation at half pixel values. In this example, interpolating quarter pixel values may provide better motion estimation but is more computationally-intensive than interpolating half pixel values. In blurry frames, images have less detail in them, and as a result, interpolating at a sub-pixel level may not be essential to preserve details of the image. Therefore, integer pixel precision may be utilized to encode motion estimation blocks, where the encoding algorithm looks that pixel values, thus avoiding the added computational complexity of interpolating pixel values.

Video encoder 110 may compare the estimated blurriness level B(n) of a frame with a threshold value in B(n) evaluation unit 114, to determine whether to implement a simplified encoding algorithm. In one example, the threshold value may be set to a default value. In another example, the threshold value may be changed based on settings in video capture device 102 and/or video encoder 110. In another example, the threshold value may be defined by a user of the system. For example, the blurriness level may be a value in the range [0,1], and by default, the threshold value may be set to 0.5, or the midpoint of the blurriness level range of values. In other examples, the threshold value may be set by user preference. If B(n) evaluation unit 114 determines that the estimated blurriness is above the threshold, B(n) evaluation unit 114 signals to encoding algorithm unit 116 to implement the appropriate simplified algorithm to encode the blurry frames.

In one example, video encoder 110 may obtain parameters associated with captured frames from video capture device 102, and may estimate the blurriness level based on the camera parameters. Video encoder 110 may then utilize the estimated blurriness level as discussed above to improve the encoding rate. In this manner, by utilizing parameters provided by video capture device 102 for frames in which blurriness is detected, video encoder 110 may estimate blurriness using calculations without having to determine whether or not a frame is blurry, as the blurriness is detected by video capture device 102 based on camera functions performed by input sensor unit 104 and motion and AF unit 106.

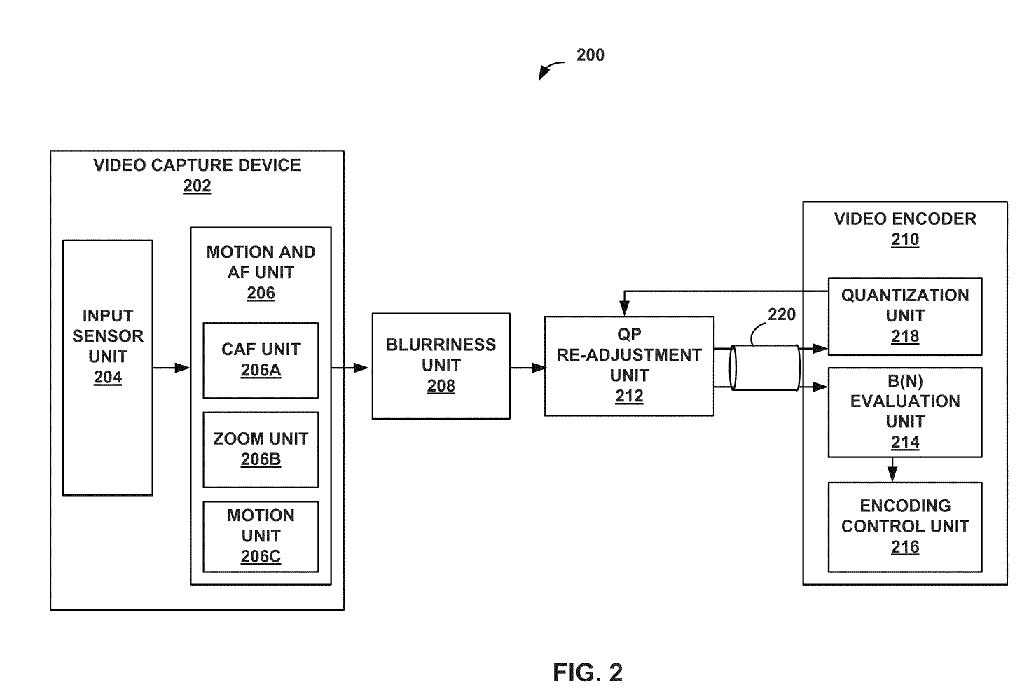

FIG. 2 is a block diagram illustrating another exemplary video capture device and video encoder system 200 that may implement techniques of this disclosure. The example of FIG. 2 substantially corresponds to the example of FIG. 1, but a portion of the calculation that the video encoder performs in FIG. 1 may be performed by video encoder 210 or by video capture device 202 in FIG. 2, as will be discussed in more detail below. As shown in FIG. 2, system 200 includes video capture device 202, e.g., video camera that captures and sends a video stream to video encoder 210 via link 220. System 200 may also include blurriness unit 208 and QP-readjustment unit 212, which may be part of video capture device 202 or video encoder 210. Therefore, in the example of FIG. 2, blurriness unit 208 and QP-readjustment unit 212 are depicted separately from either device, with the understanding that either of units 208 and 212 may be within video capture device 202 or video encoder 210. Video capture device 202 and video encoder 210 may comprise any of a wide range of devices, including mobile devices. In some examples, video capture device 202 and video encoder 210 comprise wireless communication devices, such as wireless handsets, personal digital assistants (PDAs), mobile media players, cameras, or any devices that can capture and encode video data. In some examples, video capture device 202 and video encoder 210 may be contained in the same enclosure as part of the same system. In other examples, video capture device 202 and video encoder 210 may reside in two or more different devices, and may be part of two or more different systems. If video capture device 202 and video encoder 210 reside in two or more different devices, link 220 may be a wired or wireless link.

In the example of FIG. 2, as in the example of FIG. 1, video capture device 202 may include an input sensor 204 and a motion and AF unit 206. Motion and AF unit 206 may include several functionality units associated with video capturing such as, for example, CAF unit 206A, zoom unit 206B, and motion unit 206C. Video encoder 210 may include quantization unit 218, frame blurriness evaluation unit 214, and encoding algorithm unit 216. In accordance with this disclosure, video capture device 202 may be configured to obtain parameters associated with one or more functions, e.g., zooming, panning, motion detection, which may be further processed by motion and AF unit 106, which may then be provided to blurriness unit 208. Blurriness unit 208 may estimate the level of blurriness of frames, and based on the estimated level of blurriness, QP-readjustment unit 212 may then readjust the QP. QP-readjustment unit 212 may receive from video encoder 210 the previous QP value, based on which, QP-readjustment unit 212 may compute the readjusted QP value. In one example, the readjusted QP value may be based on the level of blurriness in a frame, and encoding less blurry frames may utilize more quantization (e.g., smaller QP) and more blurry frame may utilize less quantization (e.g., larger QP), where the readjusted quantization may not exceed the previous amount of quantization used by video encoder 210. Blurriness unit 208 and QP-readjustment unit 212 may send the readjusted QP and the blurriness estimate to the video encoder 210. Video encoder 210 may use blurriness information to determine appropriate video encoding data rate and/or simplify video encoding algorithms. Video encoder 210 may use the readjusted QP during quantization. In this example, adjusting the QP based on the blurriness level estimate may further reduce computational complexity in video encoder 210. Video encoder 210 may further readjust the QP based on factors other than blurriness.

Input sensor 204 of video capture device 202 may sense frame contents for capturing. Changes in the captured scene may result in the input sensor 204 sending a signal to motion and AF unit 206, and triggering an appropriate function, e.g., refocusing during panning motion, zooming, or other types of motion, as described above in connection with FIG. 1. Motion and AF unit 206 may send an indication to blurriness unit 208 indicating presence of motion in frames and/or whether AF is performed on a frame. Blurriness unit 208 may estimate the blurriness in frames for which motion and AF unit 206 indicates motion and/or AF. Blurriness unit 208 may estimate a blurriness B(n) associated with frame n, and send B(n) to QP re-adjustment unit 212. QP re-adjustment unit 212 may utilize the blurriness level to re-adjust the QP for the frame as described above. Blurriness unit 208 and QP-readjustment unit 212 may send the blurriness estimate B(n) and the adjusted QP for frame n to video encoder 210.

Video encoder 210 may receive the blurriness estimate B(n) and adjusted QP for frames in which blur is detected, and may utilize the blurriness level in encoding the video frames, e.g., without having to perform additional calculations to determine the amount of blur in the frames, in some examples. In one example, video encoder 210 may utilize the readjusted QP to quantize the coefficient values associated with residual data for blocks in frame n, in quantization unit 218.

In addition to utilizing the readjusted QP, video encoder 210 may utilize the blurriness level to further simplify the encoding algorithm implemented by video encoder 210. A simplified encoding algorithm may be, for example, an algorithm that uses integer pixel precision, instead of fractional, for motion estimation search, as discussed above. Other encoding algorithm simplifications may involve, for example, utilize skip mode, modifying the reference picture list used in motion estimation, and modifying block partition size for prediction code and motion compensation, as explained in more detail below. In one example, video encoder 210 may determine which of the encoding algorithm simplification methods to use based on the estimated blurriness level. In one example, video encoder 210 may implement one or more methods of encoding algorithm simplification, as further discussed below. Video encoder 210 may compare the estimated blurriness level B(n) of a frame with a threshold value in B(n) evaluation unit 214, to determine whether to implement a simplified encoding algorithm and which ones to implement. In one example, the threshold value may be set to a default value. In another example, the threshold value may be changed based on settings in video capture device 202 and/or video encoder 210. In another example, the threshold value may be defined by a user of the system. If B(n) evaluation unit 214 determines that the estimated blurriness is above the threshold, B(n) evaluation unit 214 signals to encoding algorithm unit 216 to implement the appropriate simplified algorithm to encode the blurry frames.

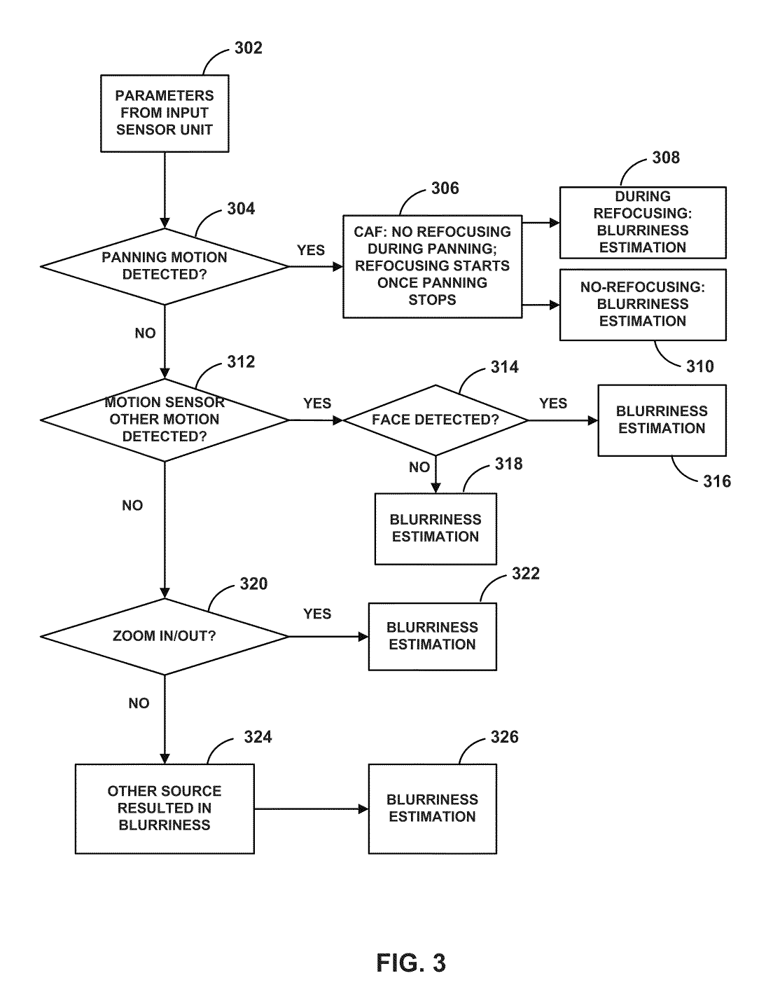

FIG. 3 is a flow diagram illustrating video capturing functions resulting in blurriness in captured frames. The flow diagram of FIG. 3 may correspond to functions performed by a video capture device such as, video capture device 102 and 202 of FIGS. 1 and 2. As the video capture device captures frames, changes in the conditions, e.g., motion of objects within the scene being captured, motion of the device, zooming, and the like, may be detected by an input sensor unit (e.g., input sensor unit 104/204). The input sensor unit may provide parameters (302) associated with the detected conditions to a motion and AF unit, e.g., motion and AF unit 106/206. The motion and AF unit may determine, based on the parameters from the input sensor unit, the type of motion associated with the captured frame, whether AF is necessary, and the type of AF to perform when AF is necessary.

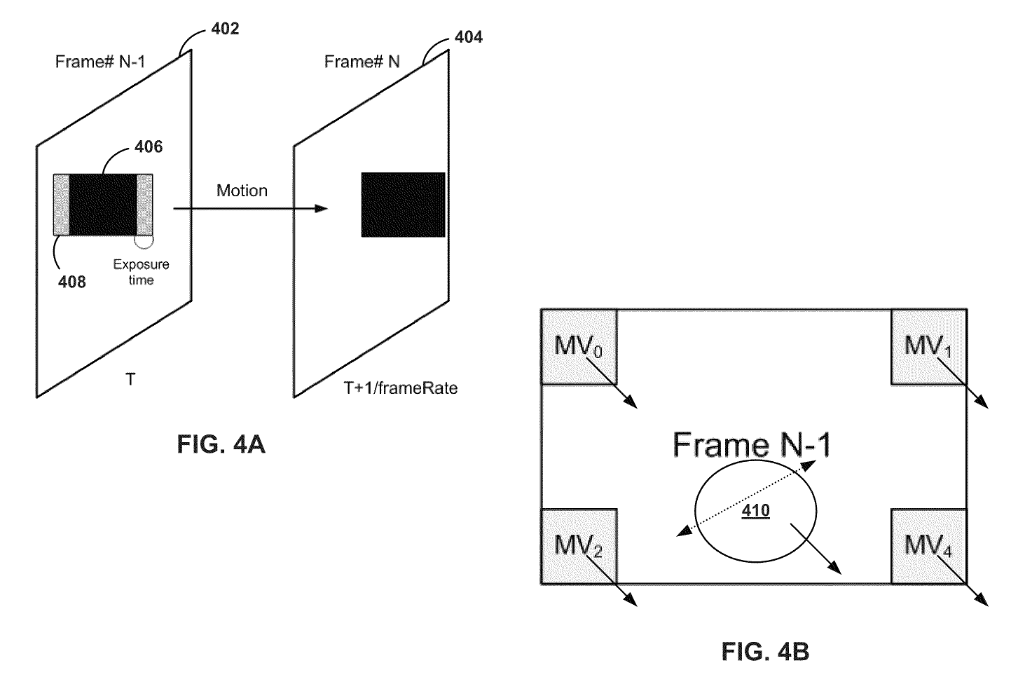

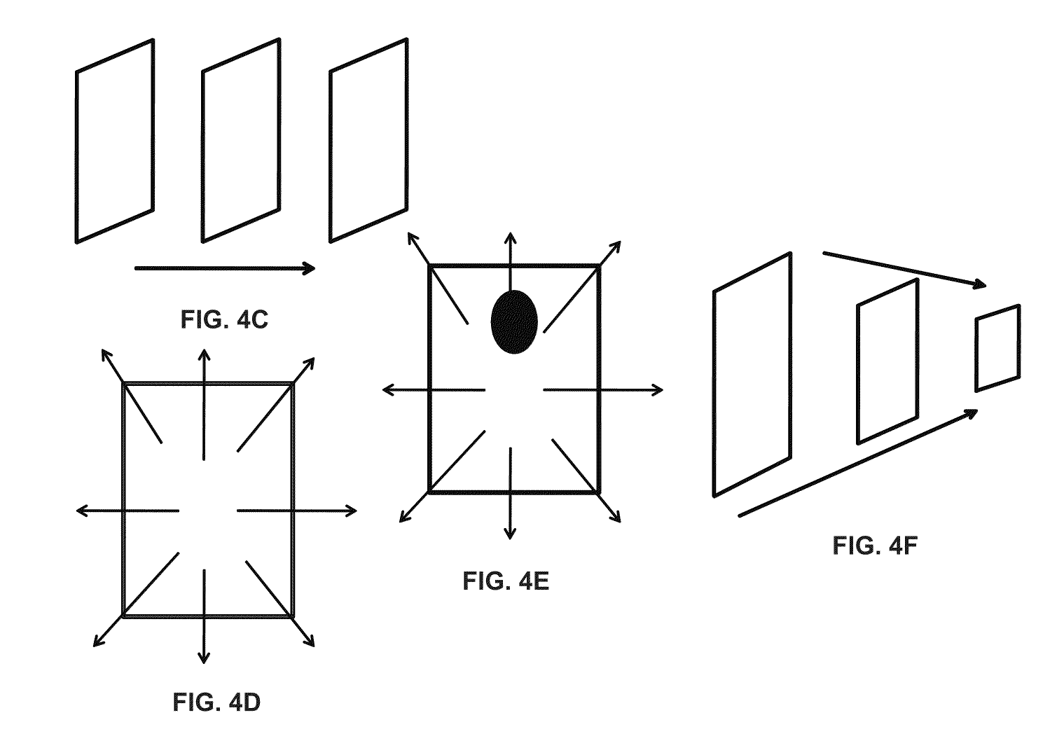

The motion and AF unit may determine whether the motion is a panning motion (304). During panning motion, the video capture device may move from one scene to another scene through physical movement of the video capture device. Therefore, the captured scene may be entirely different from the beginning of the panning motion and until the video capture device stops, or the panning motion stops. Blurriness may result during panning motion, and to be able to estimate blurriness correctly, the motion and AF unit may determine the appropriate parameters to provide the blurriness unit based on the phase of the panning motion. When panning starts and until it stops, there may be no refocusing, and as soon as panning stops, refocusing begins (306). During panning motion, blurriness may be caused by local and global motions. An example of local motion is illustrated by FIG. 4A, where an object in frame N−1 moves to a different location in frame N as the camera moves (e.g., a flower being blown around by wind or a ball traveling across a scene). If the object moves during exposure time, the object boundaries, illustrated by the shaded area in frame N−1, may appear blurry in the captured frame. Therefore, a longer exposure time allows capturing more of the change of the position of the object and results in more blur than short exposure time. Global motion may result from motion of the entire frame, as shown in FIG. 4B, as illustrated by the arrows indicating the direction of motion of the edges of the frame. The global motion may result from the camera movement. The faster the camera moves, the larger the change in the object position in the frame will be, and the greater the blurriness of the object will be.

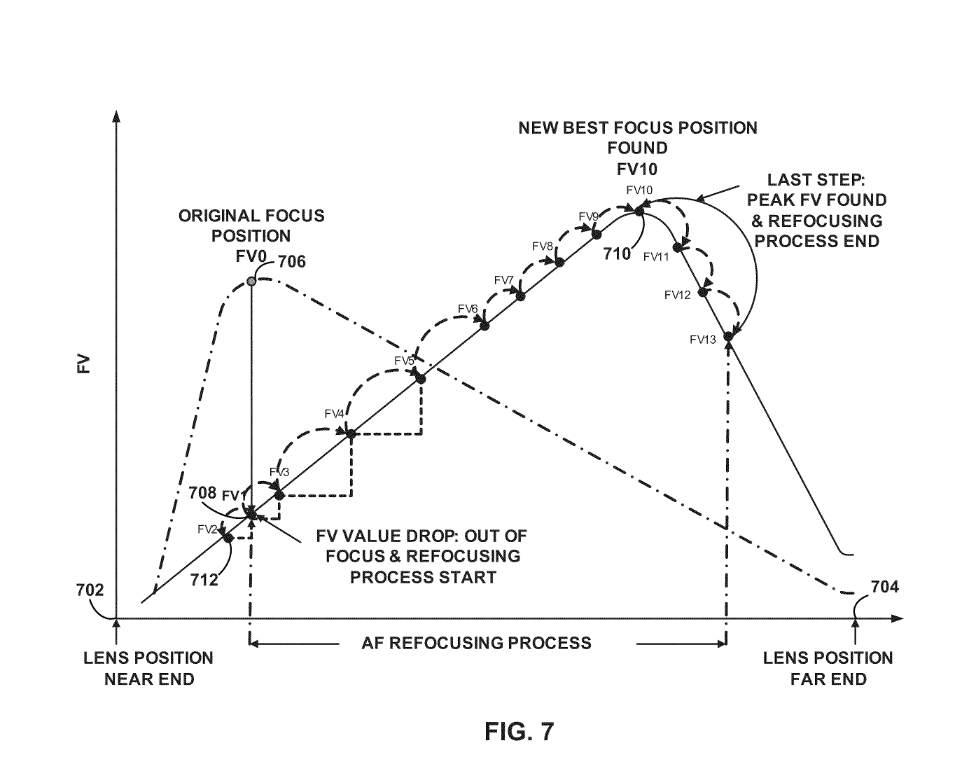

When the motion stops in a panning motion, the refocusing process may begin. CAF may be utilized to achieve refocus in panning motion, and parameters associated with CAF may be provided from the camera to the blurriness unit (e.g., blurriness unit 108 or 208) to estimate blurriness (308). The CAF process is described in more detail below with reference to FIG. 7. During the portions of panning when no refocusing is taking place, blurriness may be estimated using motion and other camera parameters, which may be provided to the blurriness unit (310), as described in more detail below. Portions of the panning motion when no refocusing should take place may be detected using global motion estimation, as will be described in more detail below.

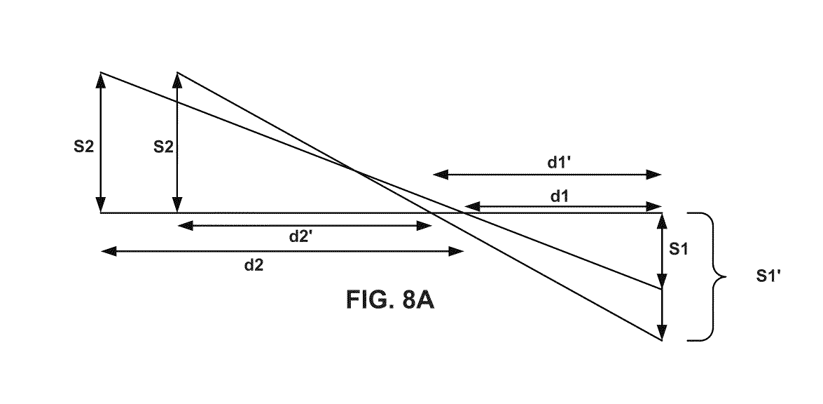

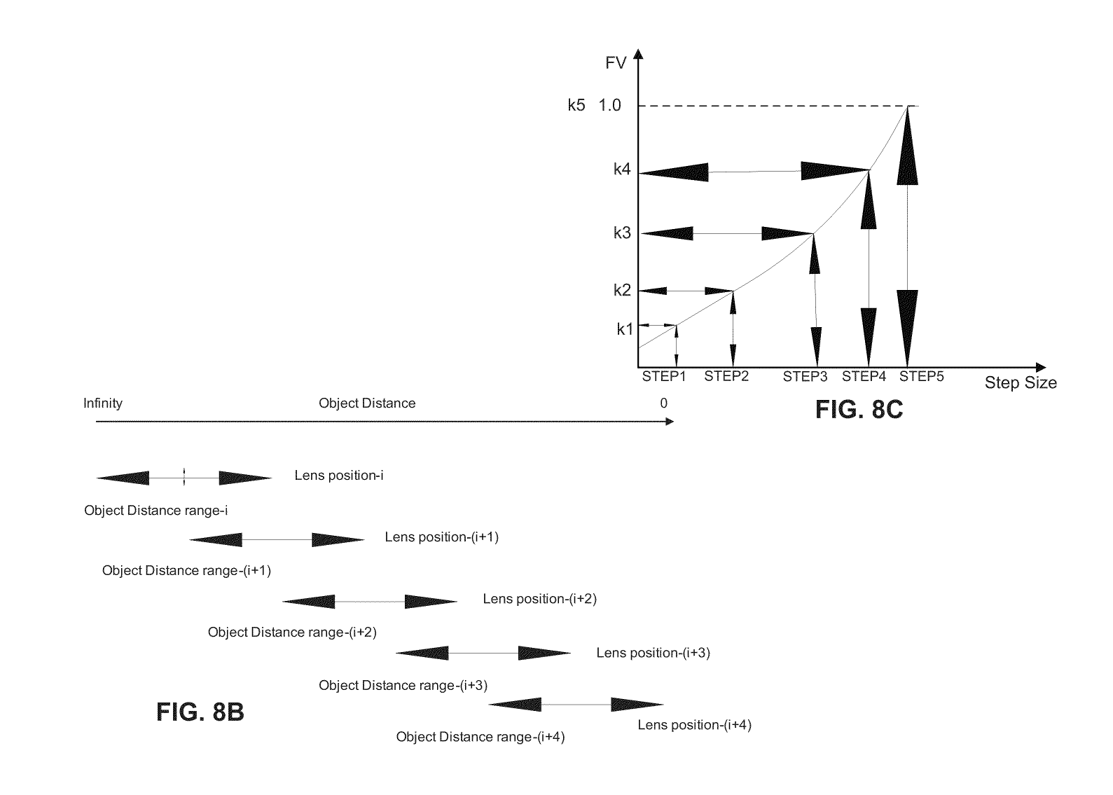

If the detected motion is not panning motion, the motion and AF unit may determine whether the detected motion is the result of another type of motion detected by the motion sensor (312). For example, the motion may be the result of the video capture device approaching an object of interest along a direction illustrated by the arrow as shown in FIG. 4C. In this example, as the video capture device moves along the direction illustrated by the arrow, the field of view keeps changing. However, as FIG. 4D shows, the motion within the frame in this type of motion is along the directions of the arrows; thus, the global motion of the frame is 0, because the motion is the same in all directions and cancels out globally, and as a result this type of motion may not be detected by the algorithm and/or sensors that detect the panning motion. However, one or more motion sensors (e.g., accelerometer) in the input sensor unit of the video capture device may detect this motion, and send information regarding the motion to the motion and AF unit. If motion is detected by the motion sensor (312), the motion and AF unit may determine whether a face is detected in the captured frames during the motion (314). If no face is detected (314), refocusing may not be necessary during the motion, and an indication of blurriness may be sent to the blurriness unit to determine blurriness using motion and other camera parameters (318). When the motion stops, CAF may be triggered to refocus and blurriness during CAF may be estimated the same as in (308). If a face is detected (314), as shown in FIG. 4E, during motion, the focus lens may be directly adjusted using parameters associated with the detected face, and blurriness may be estimated based on the lens position as adjusted for focusing on the face (316). The AF process for frames where a face is detected is described in more detail below with reference to FIG. 8.

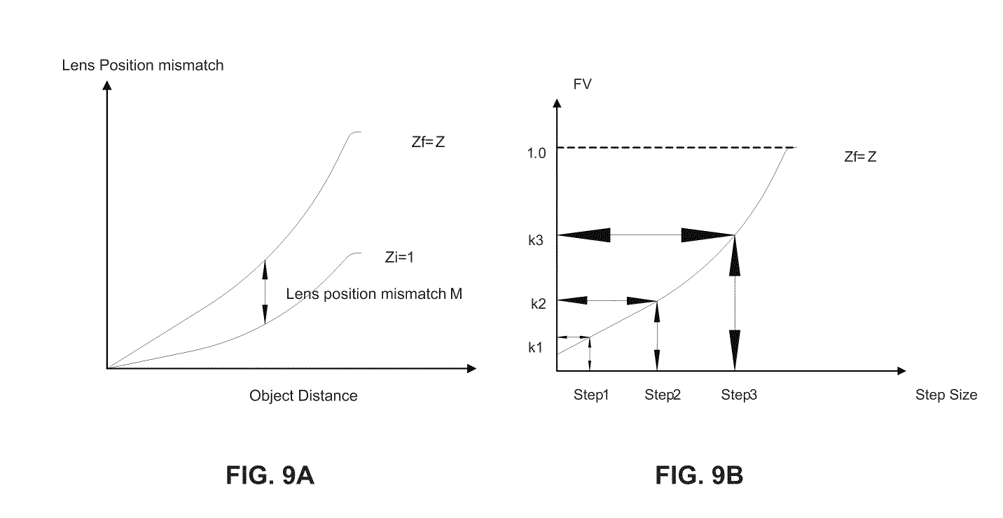

If there is no panning motion and the motion sensor does not detect motion, the motion and AF unit may determine if optical zooming is occurring (320). When the video capture device starts zooming as illustrated in FIG. 4F, the field of view changes, and blurriness may occur during the zooming process. The video capture device may utilize the available optical zooming information, e.g., zooming factor, to determine the blurriness in frames captured during zooming (322). The AF process for frames captured during zooming is described in more detail below with reference to FIG. 9.

The motion and AF unit may detect blurriness from other sources (324), e.g., motion of objects within the frame, global motion as a result of other activities, or the like. In this case, the motion and AF unit (e.g., motion and AF unit 106 or 206) may indicate detection of blurriness in the captured frames, and may provide the blurriness unit (e.g., blurriness unit 108 or 208) with parameters that the blurriness unit may utilize to estimate blurriness (326). For example, the motion and AF unit may provide motion and other camera parameters that the blurriness unit may utilize to estimate blurriness.

In each of the examples of motion discussed above, the blurriness unit may estimate the blurriness in the captured frames using the appropriate parameters. The blurriness unit may then provide the estimated blurriness level to a video encoder, which may utilize the estimated blurriness to improve the encoding rate. Estimating the blurriness in each of the above examples will be discussed in more detail below.

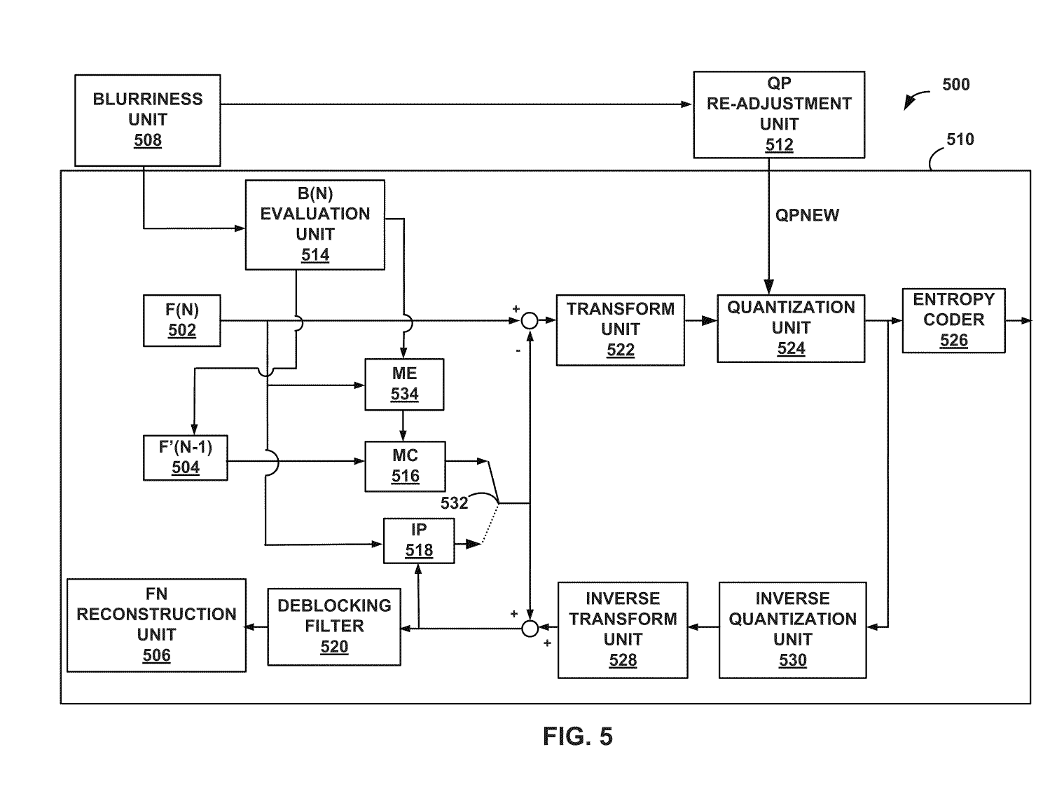

FIG. 5 is a block diagram illustrating one example of a video encoding system 500 that implements the techniques of this disclosure. As shown in FIG. 5, system 500 includes video encoder 510 in addition to blurriness unit 508 and QP re-adjustment unit 512. Blurriness unit 508 may be an example of blurriness unit 108 of FIG. 1 or blurriness unit 208 of FIG. 2. In one example, blurriness unit 508 and/or QP re-adjustment unit 512 may be part of video encoder 510. In this example, video encoder 510 may be an example of video encoder 110 of FIG. 1. In another example, blurriness unit 508 and/or QP re-adjustment unit 512 may not be part of video encoder 510. Video encoder 510 includes elements of a conventional video encoder in addition to elements that implement techniques of this disclosure. The video encoding system 500 may encode video frames captured by a video capture device, e.g., video capture device 102 of FIG. 1 or video capture device 202 of FIG. 2. F(n) 502 may represent a current frame that the video encoder is processing for encoding.

During its usual operation, i.e., while the frames are in focus and no refocusing is taking place in the video capture device or when there is no indication of blurriness in the frames, video encoder 510 may perform motion estimation on the current frame, if video encoder 510 is operating in inter-frame prediction mode. Alternatively, video encoder 510 may perform intra-frame prediction on the current frame, if operating in intra-frame prediction mode. Using selector 532, video encoder 510 may switch between inter-frame prediction and intra-frame prediction. For example, if the estimated level of blurriness in a frame exceeds a certain threshold, video encoder 510 may operate in inter-frame prediction mode by using selector 532 to activate the motion compensation unit 516. When operating in inter-frame prediction mode, video encoder 510 may utilize motion vector data for motion compensation, in addition to residual data representing the difference between the inter-frame prediction data and the current frame, as will be described in more detail below.

In one example, video encoder 510 may be operating in intra-frame prediction mode. The intra-frame prediction data may be subtracted from the current frame 502 to produce residual data, and the result may undergo a transform in transform unit 522, e.g., discrete cosine transform (DCT), to produce transform coefficients representing the residual data. The transformed frame data, e.g., transform coefficients, may then undergo quantization in quantization unit 524. Video encoder 510 may have a default QP that ensures a certain image quality, where a higher degree of quantization retains more detail in an encoded frame, but results in a higher data rate, i.e., a higher number of bits allocated to encode residual data for a given frame or block. The quantized frame data may then go through entropy coding unit 526 for further compression. The quantized frame may be fed back to inverse quantization unit 530 and inverse transform unit 528, and may combine with the result from the intra-frame prediction unit 518, to obtain an unfiltered signal. The unfiltered signal may go through deblocking filter 520, which results in a reconstructed frame, F(n), which may be used as a reference frame for encoding other frames.

In one example, input sensors, e.g., input sensor unit 104 of FIG. 1 or 204 of FIG. 2, of the video capture device, e.g., video camera, may detect when a new object of interest comes into the scene being captured, or the user may re-direct the input sensor to capture a different object or different scene, or a function is triggered that results in motion in the captured frames. Detecting a new object or a motion may cause the video capture device to initiate refocusing to reestablish focus on the new object or to detect blurriness in the captured frames if refocusing is not required. In examples where refocusing occurs, refocusing may entail adjusting the lens position until the desired focus is achieved (e.g., during CAF) or to a lens position determined based on parameters associated with the function (e.g., zooming, face detection). During refocusing, captured frames may not have the desired focus, and as a result may be blurry. Video encoding system 500 may exploit the blurriness of frames to reduce the encoding data rate for blurry frames and/or simplify encoding algorithms applied to the blurry frames.

In accordance with techniques of this disclosure, the blurriness unit 508, which may be in the video capture device or video encoder 510, may estimate the blurriness, B(n), of frames F(n). Blurriness unit 508 may send the estimated blurriness level to a QP re-adjustment unit 512, where the QP value is readjusted based on the estimated blurriness level, as described above. In one example, QP re-adjustment unit 512 may be in the video capture device. In another example, QP re-adjustment unit 512 may be in video encoder 510. QP re-adjustment unit 512 may re-adjust the QP value based on the estimated blurriness level. Video encoder 510 may re-adjust the QP value further based on other factors.

Blurriness unit 508 may send the estimated blurriness level to video encoder 510, where a frame blurriness evaluation unit 514 compares the estimated blurriness level B(n) with a threshold value, to determine whether to implement a simplified encoding algorithm. As FIG. 5 shows, if B(n) is above the threshold, blurriness evaluation unit 514 sends a signal to the motion estimation unit 510 to use a simplified encoding algorithm. In one example, simplification of encoding may include, for example, adjusting the pixel precision level as to require no or a smaller sub-pixel interpolation (e.g., ½ instead of ¼ or smaller) of pixels in motion estimation block search, which results in reducing the amount of data to be coded. For example, if the estimated blurriness level exceeds a threshold, video encoder 510 may selectively activate an integer pixel precision motion estimation search instead of fractional pixel precision motion estimation search. In this example, instead of expending computing resources to interpolate fractional pixels within a reference frame, video encoder 510 may rely on integer pixel precision and performing no interpolation. By using integer pixel precision, video encoder 510 may select a predictive block that is less accurate than a block selected using fractional pixel precision. For a frame that is already blurry, however, the reduced precision may not significantly impact image quality. Consequently, integer precision may be acceptable. By eliminating the need to perform sub-pixel interpolation, video encoder 510 performs less computations, which results in using less system resources such as power, and reduces processing time and latency during encoding.

In another example, simplification of encoding may involve adjusting block partition levels by using larger blocks within the frame for motion estimation. For example, in the H.264 standard frames may be partitions into blocks of size 16×16, 8×16, 16×8, 8×8, 8×4, 4×8, and 4×4. For example, if the estimated blurriness level exceeds a threshold, video encoder 510 may select a larger block partition, e.g., 16×16 to for motion estimation search. In this example, video encoder 510 uses less blocks for encoding a more blurry frame, than when encoding a frame that is less blurry, because each frame will be made up of less blocks and therefore, less motion vectors will be encoded for the frame. By using larger block partitions, and therefore, less blocks per frame, video encoder 510 encodes less motion vectors, which results in using less system resources.

In yet another example, simplification of encoding may include operating in skip mode, where video encoder 510 skips frames without encoding them, e.g., video encoder 510 discards these frames. If the estimated blurriness level exceeds a threshold for a sequence of frames, video encoder 510 operates on the assumption that the blurriness level is so high that a group of consecutive frames will look substantially identical. As a result, video encoder 510 may encode one of the blurry frames whose estimated blurriness level is above a certain threshold, and skip encoding of the other substantially identical frames. When the captured video is subsequently decoded and/or displayed, the one encoded frame may be decoded once, and repeated for display in place of the skipped frames. By using skip mode, video encoder 510 encodes one frame instead of a group of frames, therefore reducing the amount of computation needed to encode a video sequence, and reducing the amount of power consumed during encoding. Additionally, encoding one frame instead of a plurality of frames reduces processing time and latency during the encoding process. Video encoder 510 may also utilize skip mode with encoding blocks within frames if the estimated blurriness level is above a threshold, where video encoder 510 encodes one block and uses the encoded block in place of other blocks that may be indistinguishable because of the level of blurriness. In one example, video encoder 510 may utilize the skip mode when CAF is employed to refocus.

If B(n) is above the threshold, blurriness evaluation unit 514 also sends a signal to the reference frame unit 504. The reference frame unit 304 may set the reference frame for F(n) to the previous frame, F(n−1). The reference frame unit 504 may send the information to the motion compensation unit 516, which may perform motion compensation in the current blurry frame using inter-prediction mode, i.e., using data from other frames, instead of the current frame. Therefore, blurriness level B(n) may control selection 532 between inter mode and intra mode for prediction. The inter-frame prediction data may be subtracted from the current frame 502, and the result may undergo a transform 522, e.g., discrete cosine transform (DCT).

In accordance with techniques of this disclosure, the estimated blurriness level may be sent to the QP readjustment unit 512, which may be in the video encoder or in the video capture device. QP re-adjustment unit 512 adjusts the QP based on the amount of blurriness B(n) in the frame. In one example, if the estimated blurriness level is above a threshold, then the QP value is re-adjusted. In another example, the level of blurriness in a frame is evaluated and the QP value is readjusted based on the level of blurriness in the frame, where the amount of re-adjustment is proportional to the severity of blurriness in the frame.

In one example, the blurriness in a frame may not be too severe, and as a result, readjustment of the QP may not be preferred. As a result, quantization may be performed using the default QP value, when the estimated blurriness level does not exceed a threshold value. In another example, the QP readjustment unit 512 may determine, based on the estimated blurriness level B(n), if a certain amount of blurriness is present in the frame, to increase the QP, when the estimated blurriness level exceeds a threshold value. As the QP increases, the video encoding rate drops, but some of the detail gets lost, and the image may become more distorted. In blurry images, details of the images are already distorted, and increasing the level of quantization may have little perceivable effect on the quality of the image. The QP readjustment unit 512 may send the adjusted QP, QPnew, to the quantization unit 524. The quantization unit 524 may use QPnew to quantize the transformed residual frame data, e.g., residual data transform coefficient values, received from the transform unit 522. The quantized frame data may then go through entropy coding 526 for further compression, storage, or transmission of the encoded data. The encoder may feed back the quantized residual transform coefficient data to inverse quantization unit 530 and inverse transform unit 528, and may combine with the result from the inter-frame prediction 516, to obtain reconstructed data representing a frame or a block within a frame. The reconstructed data may go through deblocking filter 520, which results in a reconstructed frame, F(n).

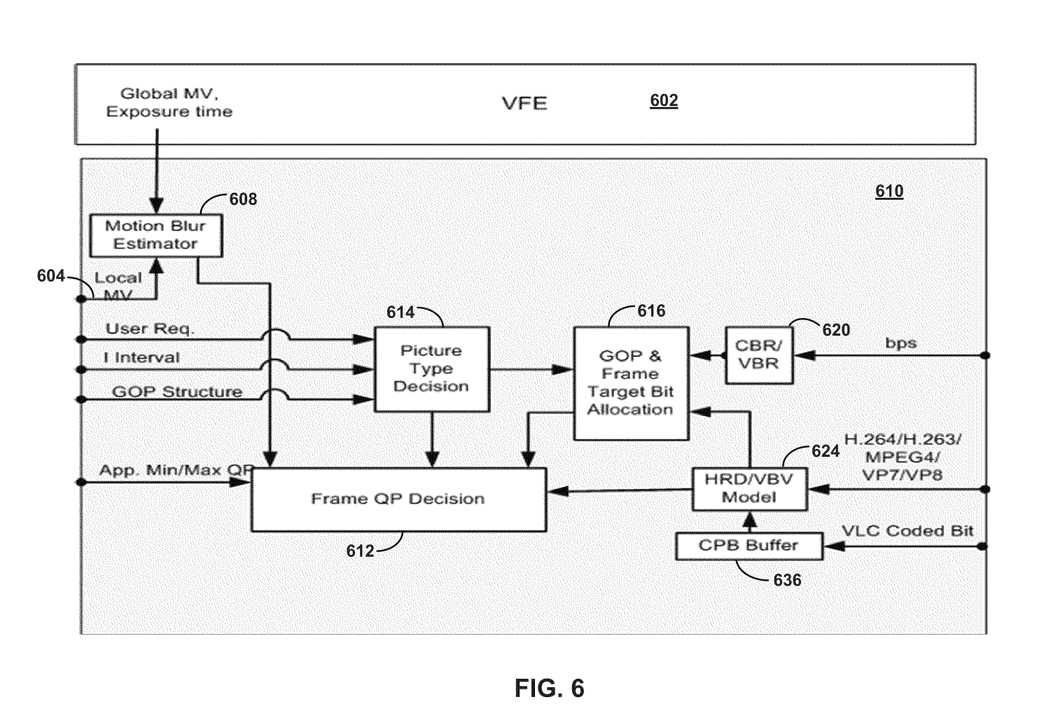

FIG. 6 is a block diagram illustrating an example of a rate control (RC) block 610 that implements the techniques of this disclosure. Rate control block 610 of FIG. 6 may perform rate control of a video encoder based on estimated blurriness in frames captured by a video capture device, e.g., video front end (VFE) device 602. RC block 610 may be part of a video encoding system, e.g., video encoder 110 of FIG. 1, video encoder 210 of FIG. 2, or video encoder 510 of FIG. 5. In one example, RC block 610 may reside inside video encoder 510 of FIG. 5. In another example, at least portions of RC block 610 may reside inside video encoder 510, and other portions may be part of blurriness unit 508 and/or QP-readjustment unit 512.

In one example, RC block 610 may receive frames of video captured by VFE device 602, including parameters associated with the captured frames, e.g., motion information. VFE device 602 may also communicate an indication of detected blurriness in a frame, based on the detected motion, and the type of detected motion. Motion blur estimator block 608, which may be similar to blurriness estimation unit 108 or 208, may estimate blurriness of a captured frame based on information communicated from VFE device 602, as described in this disclosure. The encoding of the captured frame may then be adjusted using the estimated blurriness.

Motion blur estimator block 608 may send an estimated blurriness value to frame QP decision block 612, which may be part of QP-readjustment unit 512. QP decision block 612 may adjust the QP value for encoding the corresponding frame based on the estimated blurriness, as described in more detail below. RC block 610 may also comprise picture type decision block 614, which may decide whether to code a current frame using intra or inter coding and the appropriate mode. The type of picture selected by picture type decision block 614 may also be used to determine the QP value for encoding the frame, where the QP may be used to select the level of quantization applied to residual transform coefficients produced by transform unit 522. This QP value may change based on the estimated blurriness of the frame for frames with blurriness.

RC block 610 may also include constant bit rate (CBR) or variable bit rate (VBR) block 620 which provides the bit rate used in encoding captured frames. RC block 610 may also include hypothesis reference decoder (HRD) or video buffer verifier (VBV) block 624, which provides a limit target for coded bits per frame (e.g., 137008 bits). HRD/VBV block 624 may depend on codec types, e.g., H.264/H.263/MPEG-4/VP7. HRD/VBV block 624 may determine the limit target for coded bits using information from coded picture buffer (CPB) block 636, which is based on decoder-side buffer size. The bit rate from CBR/VBR block 620 and target limit for coded bits by HRD/VBV block 624 may be provided to GOP and frame target bit allocation block 616, which allocates target coded bits for a current picture based on a picture type, and bit rate constraints generated by CBR/VBR block 620, and limits provided by HRD/VBV block 624. Therefore, for a given bit rate constraint (bits per second), RC block 610 may derive target coded bits for a frame, where the target coded bits may be limited by the constraints defined by HRD/VBV block 624.

In one example, for certain types of motion, where CAF or AF is not performed, the blurriness may be detected based on motion during which refocusing may not be performed. In this example, VFE device 602 may communicate global motion vector information and exposure time associated with the captured frame. Motion blur estimator block 608 may determine based on the global motion vector information from VFE device 608 and local motion vector information 604 whether the global motion vector indicates true global motion in the frame, as will be described in more detail below. If motion blur estimator block 608 determines that the global motion vector indicates true global motion in the frame, motion blur estimator block 608 may estimate the blurriness of the frame using the global motion vector and the exposure time, as described in more detail below. If motion blur estimator block 608 determines that the global motion vector indicates false global motion in the frame, motion blur estimator block 608 may not estimate blurriness in the frame, and the frame may be encoded as it would normally would when no blurriness is detected in the frame and without adjusting the QP value.

FIG. 7 is a diagram illustrating an example continuous auto-focus refocusing process, which may be referred to as a CAF process. In one aspect of this disclosure, the CAF functionality may be implemented in the video capture device, e.g. video capture device 102 of FIG. 1 or video capture device 202 of FIG. 2. CAF refocusing may be utilized during refocusing once motion stops, when panning motion is detected. The CAF process may be, for example, a passive auto-focus algorithm, which may include, among other functionalities, a contrast measure and a searching algorithm, which may be performed by CAF unit 106A (FIG. 1) or 206A (FIG. 2). The contrast measure may be based on the focus value (FV) obtained by high pass filtering the luma values over a focus window in the captured frame. The auto-focus algorithm may determine that the best or an optimal focus is achieved when the highest contrast is reached, i.e., when the FV peaks. The CAF unit may implement the searching algorithm to adjust the lens position in the direction of reaching the highest or most optimal contrast, i.e., where FV peaks, such that the best or an optimal focus may be achieved within a frame.

As shown in FIG. 7, the focus value (FV) may be plotted as a function of lens position. The range of lens position may represent the range of the lens of a video capture device, e.g., a video camera, ranging from a near end lens position (702) to a far end lens position (704). A frame at an optimal focus may have a peak focus value of FV0 (706). In this example, a new object may come into the frame resulting in a signal that triggers CAF unit 106A or 206A to initiate the refocus the process. At that point, the focus value of the frame may drop from FV0 (706) to FV1 (708), while the lens position has not yet begun to change. The lens position may then be adjusted step-by-step, until a new optimal or peak focus value is reached. In this example, the optimal focus value may be FV10 (710), at a new lens position. During the refocus process, the video capture device system may determine the focus value at each lens position until the optimal value is achieved. In determining the searching direction, i.e., whether the lens position is to go towards the near end (702) or the far end (704), when refocus is triggered, the searching direction may be estimated by finding the direction in which the FV increases. In this example, the first value of the refocus process may be FV1 (708). In the next step, the lens position may go towards the near end (702), and the corresponding focus value FV2 (712) may be determined, which in this case may be less than FV1 (708). Since FV2 (712) is less than FV1 (708), the video capture device system determines that the search direction should be towards the far end (704) of the lens position, thus, away from FV2 (712).

With every change in the lens position, a frame is captured, and the focus value is determined, as illustrated by FV3-FV9. In one example, when FV10 (710) is reached, the lens position may continue changing in the same direction, in this example toward the far end position (704), until a specific number of steps in a row gives a lower focus value than one already reached. For example, FV10 (710) is reached, and in this system the number of extra steps may be set to three. As a result, the lens position may increase three more steps resulting in FV11, FV12, and FV13, all lower than FV10 (710). The video capture device may then determine that FV10 (710) may be the new optimal focus value and return to the lens position corresponding to FV10 (710).

As mentioned above, the blurriness level may be determined for every frame captured between FV1 (708) and until FV10 (710) is allocated as the new best focus value. The blurriness level at each step may be utilized as described above, i.e., to determine whether to readjust the QP for encoding the associated frame and, in some cases, to determine how much to adjust the QP. The level of the blurriness of a frame may be also compared to a threshold to determine whether to simplify the encoding algorithm for the frame. Blurriness estimation during CAF refocusing may correspond to blurriness estimation (308) during refocusing associated with panning motion.

In one example, the blurriness level of a frame may be determined based on the focus value of the frame and the focus value of the preceding frame. The initial blurriness level B(1) may be estimated based on the percentage of the focus value change after the initial drop, i.e., from FV0 (406) to FV1 (708), compared to the original focus value, i.e., FV0, as follows:

$${B}_{1} = \frac{\vert {FV}_{1} - {FV}_{0} \vert}{{FV}_{0}}$$

When the searching direction is determined, as discussed above, the lens may be adjusted step-by-step to achieve the best focus position. The blurriness during this process may be evaluated as follows:

$${B}_{i} K \frac{{G}_{i}}{{FV}_{i}} \{ \begin{matrix}if & {B}_{i} < 0 , & {B}_{i} = 0 \\ if & {B}_{i} > 1 , & {B}_{i} = 1\end{matrix} {B}_{i} ∈ [ 0 , 1 ] i = 1 , 2 , …$$

where K may be an adjustable constant used to normalize the blurriness level to a selected range, e.g., [0,1]. Bi is estimated blurriness level for frame i and FVi is the focus value associated with frame i. In one example, the default value of K may be FV1, because FV1 is the initial FV value when the refocusing process starts. By setting K to FV1, the blurriness level during the refocusing process is normalized to the initial FV value, which results in normalizing the blurriness level to the range [0,1]. Gi is the absolute value of the gradient and may be computed as follows:

$${G}_{i} = \vert \frac{{FV}_{i} - {FV}_{i - 1}}{{LensP}_{i} - {LensP}_{i - 1}} \vert$$

where LensPi is the lens position corresponding to FVi, the focus value of the current frame, and LensPi−1 is the lens position corresponding to FVi, the focus value of the previous frame.

In one example, when the peak value of FV_{N} is determined, the refocus process may end, and the blurriness may be reset to its initial value indicating that the frame is in focus. In this example, the blurriness may be reset to zero, B_{N}=0.

In one example of this disclosure, CAF may not run for each frame. If there is a frame skip during the refocusing process, the blurriness level for skipped frames may be kept the same as a previously-computed one:

Bᵢ=Bᵢ₋₁

In one aspect of this disclosure, the blurriness as described above may be determined in real-time, and may enable real-time or substantially real-time encoding where blurriness levels may be utilized to control video data rate and/or simplification of encoding algorithms.

In another aspect of this disclosure, blurriness may be evaluated during CAF refocusing with a delay. The blurriness B[i] for a frame i may be estimated during CAF refocusing process by evaluating the lens position difference between the lens position of the new focal plane and the previous lens position during the refocusing process, e.g., as indicated by the following equation:

B[i]_{WithDelay}=k|LensPosition[N]−LensPosition[i]|

N is the index of the lens position at the end of the refocusing process, when the new focal plane may be found, and i=0, . . . , (N−1). k is an adjustable constant, LensPosition[i] is the lens position associated with the new focal plane, and LensPosition[N] is the lens position associated with the previous refocusing process.

In one example, it may be desired to limit the value of the blurriness level to a certain range, and the value of the constant k may depend on the defined range. For example, the blurriness level may be limited to the range [0,1], and in such an example

$$k = \frac{1}{\vert LensFarEnd - LensNearEnd \vert}$$

Where LensFarEnd is the maximum lens position and LensNearEnd is the minimum lens position.

In an example where the blurriness may be evaluated on a delayed basis, the distance from the current lens position to the desired lens position, i.e., the lens position corresponding to the best focus, may be evaluated more accurately once the best focus position is determined. In this example, the blurriness may be only determined for the frames in between the initial position and the best focus position. During the CAF refocusing process, blurriness may be evaluated at each searching step, frame-by-frame.

FIGS. 8A-8C are graphical representations illustrating auto-focus refocusing process associated with face detection. As noted above, during certain types of motion, refocusing may not be necessary unless a face is detected in the frame, as illustrated in FIG. 4C. When a face is detected, the lens may be adjusted using parameters associated with the detected face. Typically, the captured face size is inversely proportional to object distance, where the object is the face that is detected. This relationship is based on a fixed focal length, f, associated with the video capture device. Therefore, by knowing the face size, the lens adjustment needed to achieve focus may be obtained using calculations. In this manner, the trial-and-error method of AF search used in CAF, as described above, may not be necessary.

When a face is detected, the AF function may begin refocusing. The distance of the object (e.g., d2 or d2′ in FIG. 8A) may be calculated using the face size, a distance associated with the lens, and the size of the object or the face being captured. The face size Fs (e.g., S1 or S1′ in FIG. 8A) may be determined based on the frame size, and the amount of space occupied by the face in the captured frame, and may be measured by an image sensor. The distances d1 or d1′ may be the distance within the camera associated with the face, or the lens length. In one example, an average human face size S2 may be used in the calculation. Based on the proportionality relationship stated above, where:

$$\frac{1}{{d}_{1}} + \frac{1}{{d}_{2}} = \frac{1}{f} and \frac{{d}_{2}}{{d}_{1}} = \frac{{S}_{2}}{{S}_{1}}$$

the distance of the object (d2 or d2′) may be determined as follows:

$${d}_{2} = \frac{{S}_{2}}{{S}_{1}} \times {d}_{1}$$

The calculated object distance, d2, may then be used to determine the appropriate lens position to achieve focus. In one example, d2 may be the initial object distance, and d2′ may be the new object distance after camera motion of approaching the face, therefore, initiating refocus. Using the equations above, d2′ may be calculated, and the change in object distance may be used to determine a lens position mismatch.

FIG. 8B illustrates a graphical representation of different ranges of object distances relative to the lens, from 0 to infinity. Based on which range d2′ falls into, the corresponding lens position may be selected. The lens position may then be adjusted to the corresponding lens position, which may require a number of steps for the lens to go from the starting position (e.g., the lens position corresponding to d2) to the ending lens position (e.g., the lens position corresponding to d2′). The number of steps may vary by lens position mismatch, and may correspond to the number of steps of lens adjustments the lens goes through to achieve the corresponding ending lens position and focus. Additionally, the size of each step may vary according to a predetermined relationship (as shown in FIG. 8C), and each step may correspond to a value, K, between 0 and 1. Table 1 below shows an example lookup table that may be used to determine the lens position, the number of steps, and the value K corresponding to the object distance d2, based on the range [R_{N},R_{N+1}] in which d2 falls.

TABLE 1

| Object | | | |
|---|---|---|---|
| Distance Range | Lens position | Step number | Each Step Size |
| [R1, R2] | L1 | N1 | N1\|K1, k2, k3, k4, . . . |
| [R2, R3] | L2 | N2 | N2\|K1, k2, k3, k4, . . . |
| [R3, R4] | L3 | N3 | N3\|K1, k2, k3, k4, . . . |
| [R4, R5] | L4 | N4 | N4\|K1, k2, k3, k4, . . . |

Given a particular calculated object distance d2, an object distance range may be determined in which d2 falls. The corresponding lens position L(d2) to achieve focus may be determined, and the number of steps N(d2) to get to the lens position and achieve refocus may be determined. The size of each step between lens positions to achieve the lens position may be the same, and may be mapped to a corresponding curve (e.g., FIG. 8C) and a value K, where K may be a value between 0 and 1.

In one example, a frame may be captured at each step until the corresponding lens position is achieved. Therefore, each frame may have a corresponding K value as a function of the detected face size, Fs. Blurriness may be estimated for each frame during AF for face detection as follows:

Bᵢ=1.0−Kᵢ(Fₛ)

Kᵢ, as noted above, is a value between 0 and 1. Therefore, the blurriness level Bᵢ may also be a value in the range [0,1]. Blurriness estimation during AF refocusing when a face is detected may correspond to blurriness estimation (316), and may be generated by blurriness unit 108, 208, 508, or 608.

In one illustrative example, the average human face size, S₂, may be assumed to be 0.20 m. In the camera view, the original size of the face, S₁(org), may be 0.0003 m. As the camera moves closer to the face, the size of the detected face, S₁(final), may be 0.0006 m. If d₁=0.006 m, f=0.001 m, the distance from the camera, d₂, changes from d₂(org)=S2×d1/S1(org)=0.2*0.006/0.0003=4 m to d₂′=S2×d1′/S1′; where d1′ may be obtained using the equation 1/d2′+1/d1′=1/f, resulting in d2′=0.334 m. Using the lookup table, in one example:
Object distance range
   [R1, R2)=[10 m,2 m)
   [Ri, R(i+1))=[1 m,0.5 m)
Lens Position to achieve focus for object in range
   [R1,R2) is L1=36
   [R2, R3] is L2=6
Lens position change is L1−L2=30 steps
Step numbers to achieve focus again: N1=5
Each step size: step1=8, step2=6, step3=6, step4=5, step5=5
Measured normalized FV for each step: k1=0.1, k2=0.3, k3=0.6, k4=0.8, k5=1.0, when the normalized FV reaches 1.0, refocus is achieved.
   For each step change, blurriness may be estimated according to the equation above:
B1=1.0−k1=0.9; B2=1.0−k2=0.7; B3=1.0−k3=0.4; B4=1.0−0.9=0.2; B5=1.0−1.0=0.
   When the estimated blurriness gets to 0, it indicates that the frame is in focus again.

FIGS. 9A-9B are graphical representations illustrating an auto-focus refocusing process associated with zooming. As noted above, during zooming, refocusing may be achieved by adjusting the lens using parameters associated with the zooming factor, Z_{f}. A lens position mismatch factor, M, may be determined based on the change from an initial zoom factor, Zᵢ, to the desired zoom factor, Z_{f}, as FIG. 9A illustrates. Each zoom factor associated with the lens may have a corresponding lens position mismatch curve based on object distance. At a certain distance, the lens position mismatch factor, M, may be the difference between the lens position mismatch values at that distance for each of the zoom factors, Zᵢ and Z_{f}. Using a lookup table, the number of steps, N, to achieve focus for a particular lens position mismatch factor M. Each step of the N steps to achieve focus may correspond to a step value K, based on the curve associated with the desired zooming factor (FIG. 9B), and normalized, therefore, the value K is in the range [0,1]. Table 2 below shows an example lookup table that may be used to determine the number of steps, N, and the value K for each of the steps corresponding to a lens position mismatch, M.

TABLE 2

| Lens position mismatch | Step number | Each Step Size |
|---|---|---|
| M1 | N1 | N1\|K1, k2, k3, k4, . . . |
| M2 | N2 | N2\|K1, k2, k3, k4, . . . |
| M3 | N3 | N3\|K1, k2, k3, k4, . . . |
| M4 | N4 | N4\|K1, k2, k3, k4, . . . |

In one example, a frame may be captured at each step until the corresponding zoom position is achieved. Therefore, each frame may have a K value as a function of the zoom factor, where K corresponds to the N steps needed to cover the lens position mismatch factor associated with zoom factor Z_{f}. Blurriness may be estimated for each frame during AF for zooming as follows:

Bᵢ=1.0−Kᵢ(Z_{f})

Kᵢ, as noted above, is a value between 0 and 1. Therefore, the blurriness level B, may also be a value in the range [0,1]. Blurriness estimation during AF refocusing when zooming is detected may correspond to blurriness estimation (322), and may be generated by a blurriness unit (e.g., blurriness unit 108, 208, 508, or 608).

In one illustrative example, the zoom factor Z_{f}=2. The corresponding lens position mismatch may be: M/=5. Using a lookup table, the number of steps to get back to focus position: N1=3, the corresponding step size: Step1=2 (lens position step size); step2=2; step3=1, and the measured normalized FV for each step may be K1=0.4; K2=0.8; K3=1.0 (a K value of 1 may indicate peak FV or focused). Using the blurriness estimation equation above, the estimated blurriness level at each step may be:

B1=1.0−K1(Zf=2)=1.0−0.4=0.6

B2=1.0−K2(Zf=2)=1.0−0.8=0.2

B3=1.0−K3(Zf=2)=1.0−1.0=0
Where Ki(Zf) represents that Ki is a function of Zf.

Referring back to FIGS. 4A-4B, several types of motion may result in blurriness, where no AF is performed. Blurriness estimation based on motion, e.g., object motion and/or camera motion, may require determining the motion vectors associated with the detected motion. This blurriness estimation may correspond to blurriness estimation (310) corresponding to motion during panning motion, blurriness estimation (318) corresponding to the motion illustrated in FIGS. 4C-4D, which may involve object motion, and blurriness estimation (326) corresponding to object motion and/or device motion (e.g., panning or hand jitter).

Object motion, as illustrated in FIG. 4A, may correspond to local motion and may be estimated using a motion estimation algorithm. Device motion, as illustrated by FIG. 4B, may correspond to global motion and may be estimated using a motion sensor in the input sensor unit of the video capture device, e.g., accelerometer. The total motion associated with a frame may be estimated and quantified using a motion vector (MV), which indicates an amount of displacement associated with the motion. The total motion, MV, associated with a frame may be:

MV=|MV_{device}|+|MV_{object}|

Where MV_{device} indicates the movement of the device as a result of such events as panning or hand jitter, for example. In one example, global motion, MV_{global}, may be used to estimate or express MV_{device}. MV_{object} indicates object movement within the captured frame.

In one example, estimation of blurriness of a frame resulting from global and/or location motion may utilize three main parameters: exposure time, frame rate, and global MV and/or local MV. As noted above, with reference to FIG. 4A, motion blur is related to exposure time, where longer exposure time causes greater blur. As FIG. 4A shows, object 406 may overlap with the background if object 406 moves during exposure time, i.e., while frame 402 is being captured by a video capture device, resulting in a blurred region 408. Two scenes, e.g., frames 402 and 404, overlap resulting in blur, if transition is fast during exposure, i.e., if the device moves during exposure time, causing the position of object 406 to change within the frame from one frame to the next.

In one example, the parameters used to estimate motion blurriness may be obtained from the video capture device, which results in little to no overhead in the video encoder. As noted above, blurriness may be proportional to exposure time and global motion vector, which may be related to the amount of movement of the device. Additionally, bluriness is proportional to the frame rate, because a higher frame rate implies higher panning speed for a given MV, and therefore, results in greater blurriness. To determine blurriness, the velocity, v, of the motion may be determined as follows:

v_{y}=mv_{y}×p×f

vₓ=mvₓ×p×f and

Where mv is a quad-pixel motion vector, p is inch per quad-pixel, and f is the frame rate. Blurriness B is proportional to

|v|_{∞}×α

Where α is the exposure time associated with video capture device. As a result, blurriness of a frame may be estimated as follows for a given exposure time, frame rate, and global MV:

B=|MV|_{∞}×f×α

In determining MV, global motion and local motion may be considered. Global motion may be determined in the video capture device using a global motion estimator. For example, the global motion estimator may be a digital image stabilization (DIS) unit, which may determine global MV for image stabilization. In a frame, local motion of large objects in a frame (illustrated by the dotted line in FIG. 4B), the motion of the 4 edges is close to 0, so local MV may be small, but global MV may be large based on the motion of large object 410. In this case, the large global MV may not represent true global motion, as it is the result of motion within the frame, and not motion of the entire frame, as would be the result of hand jitter or panning motion. If it is determined that the large global MV does not represent true global motion, then blurriness may not be estimated for the frame, because most likely, only a portion of the frame contains blurriness, such as in the example of one object 410 moving, where everything else in the image may remain in focus and not blurred. In true global motion, both local and global MV should be large, where motion of object 410 and the 4 edges have a large value. Therefore, when estimating blurriness for a frame, local MV may be determined and used to add more accuracy to global MV in cases where the source of the global MV may not be trusted. For example, if the global MV is determined using a trusted sensor (e.g., a gyroscope or an accelerometer), local MV information may not be necessary. In another example, if the global MV is determined using a motion estimator algorithm, it may be useful to determine local MV to ensure accurate global MV.

Local MV may be determined using motion estimation in an encoder, which may be utilized for other encoding purposes, therefore, determining local MV may not introduce additional computation or complexity to the encoder. As noted above, global MV may be determined in the video capture device. If the global MV is not trusted (e.g., determined by a motion estimator algorithm), both the local and global MVs may be compared to threshold values to determine whether true global motion exists in the frame. If true global motion exists in the frame, blurriness may be estimated using MV as noted above. If true global motion does not exist in the frame (e.g., motion of a large object within frame), then blurriness may be localized, and blur estimation may not be performed, because the entire frame may not have enough blur to justify using blurriness to adjust the QP for encoding the frame.

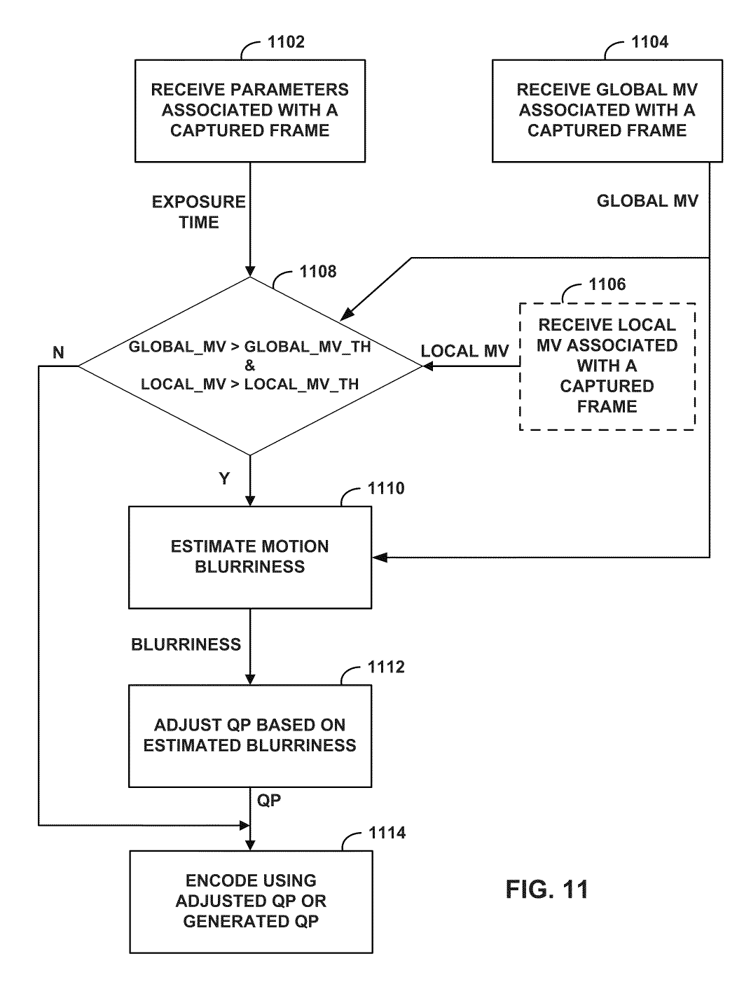

FIG. 11 illustrates one example of estimating motion blurriness, in accordance with techniques of this disclosure. In the example of FIG. 11, a camera module, which may be part of a video capture device, may provide parameters associated with a captured frame (1102), including exposure time, for example. Another module or a processor that executes an algorithm in the video capture device, e.g., digital image stabilization, may determine a global MV associated with the captured frame (1104). The global MV and exposure time may be provided to a blurriness unit (e.g., blurriness unit 108 or 208). If the source of the global MV is not entirely trusted, as noted above, a local MV associated with the frame may be optionally obtained from motion estimator (1106). A determination whether both the local MV and the global MV exceed a certain threshold associated with each may be made (1108), to determine whether the global MV indicates true global motion. Additionally, the comparison to the thresholds may also indicate whether the amount of motion exceeds a certain amount that may be indicative of a threshold level of blurriness in the frame. In one example, the source of the global MV may be trusted (e.g., gyroscope or accelerometer), and a local MV may not be needed to determine whether the global MV indicates true global motion. In this example, a determination whether the global MV exceeds a threshold associated with the global MV may be made (1108).

If at least one of the local and global MVs does not exceed the corresponding threshold, or in the example where only the global MV is compared to the threshold, if the global MV does not exceed the corresponding threshold, then there is no true global motion or there is no significant global motion in the frame, and therefore, no blurriness from motion. Therefore, blurriness need not be determined, and the frame may be encoded as it normally would be encoded using a QP value that is generated according to the encoder design or the standard (1114). If the local and global MVs both exceed the corresponding thresholds, or in the example where only the global MV is compared to the threshold, if the global MV exceeds the corresponding threshold, then global motion exists in the frame, and motion blurriness may be estimated using a motion blurriness estimator (1110), which may implement the motion blurriness using the global MV, exposure time, and frame rate, as discussed above. The estimated blurriness may then be sent to a QP decision block to adjust the QP accordingly (1112), as will be discussed in more detail below. The frame may then be encoded using the adjusted QP value (1114).

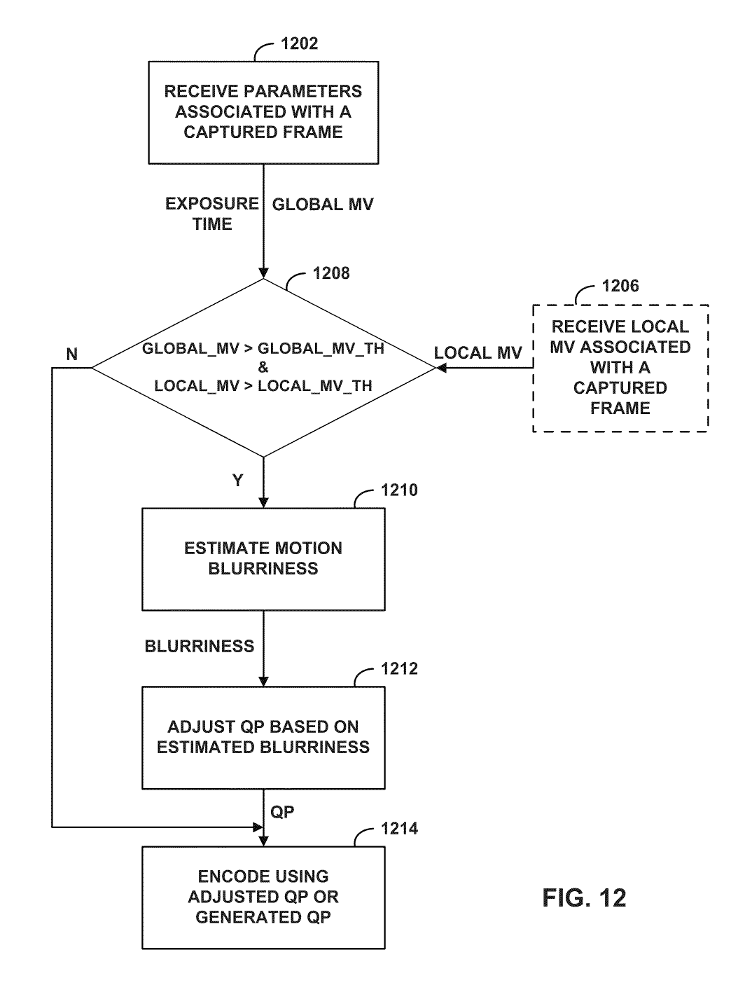

FIG. 12 illustrates another example of estimating motion blurriness, in accordance with techniques of this disclosure. The example of FIG. 12 is similar to the example of FIG. 11 discussed above. However, the global MV in the example of FIG. 12 may be determined by camera module 1202, e.g., using a global MV estimator or a sensor (e.g., gyroscope or accelerometer).

In the example of FIG. 12, a camera module, which may be part of a video capture device, may provide parameters associated with a captured frame (1202), including exposure time and global MV, for example. The global MV and exposure time may be provided to a blurriness unit (e.g., blurriness unit 108 or 208). If the source of the global MV is not entirely trusted, as noted above, a local MV associated with the frame may be optionally obtained from motion estimator (1206). A determination whether both the local MV and the global MV exceed a certain threshold associated with each may be made (1208), to determine whether the global MV indicates true global motion. Additionally, the comparison to the thresholds may also indicate whether the amount of motion exceeds a certain amount that may be indicative of a threshold level of blurriness in the frame. In one example, the source of the global MV may be trusted, and a local MV may not be needed to determine whether the global MV indicates true global motion. In this example, a determination whether the global MV exceeds a threshold associated with the global MV may be made (1108).

If at least one of the local and global MVs do not exceed the corresponding thresholds, or in the example where only the global MV is compared to the threshold, if the global MV does not exceed the corresponding threshold, then there is no true global motion in the frame or there is no significant global motion in the frame, and therefore, no blurriness from motion. Therefore, blurriness need not be determined, and the frame may be encoded as it normally would be encoded using a QP value that is generated according to the encoder design or the standard (1214). If the local and global MVs both exceed the corresponding thresholds, or in the example where only the global MV is compared to the threshold, if the global MV exceeds the corresponding threshold, then global motion exists in the frame, and motion blurriness may be estimated using a motion blurriness estimator (1210), which may implement the motion blurriness using the global MV, exposure time, and frame rate, as discussed above. The estimated blurriness may then be sent to a QP decision block to adjust the QP accordingly (1212), as will be discussed in more detail below. The frame may then be encoded using the adjusted QP value (1214).

As noted above, the QP value may be readjusted using estimated blurriness to improve encoding rate. In frame in which blurriness is detected, the blurriness may be estimated as discussed above, using the method corresponding to the type of motion or function that causes the blurriness, e.g., panning, hand jitter, zoom, and CAF. The QP for encoding the current frame may be readjusted for data rate saving according to the estimated blurriness level of the frame content. In one example, the more blurry a frame is, the less quantization used to encode the corresponding frame, since less sharp edge information and less detail may be in the frame. In some examples, the degree of quantization may be proportional to the QP value. In some examples, the degree of quantization may be inversely proportional to the QP value. In either case, the QP value may be used to specify the degree of quantization. Therefore, a lower encoding data rate may be allocated for the more blurry frames. The resulting savings in coding rate may be used, in some examples, to allocate more coding bits to non-blurry frames, or frames with less blurriness.

In the example of blurriness caused by CAF, the QP re-adjustment may be determined by the QP readjustment unit 112 (FIG. 1) or 212 (FIG. 2) as follows:

$${QP}_{i}^{new} = {QP}_{0}^{org} + a \times \frac{{QP}_{max} \times {B}_{i}}{{QP}_{0}^{org}}$$

QPₘₐₓ may be the maximum QP value allowed in a particular video encoding system. In this example, quantization may be proportional to the QP value, e.g., as in H.264 encoding. For example, in H.264, QPₘₐₓ=51;
QPᵢ^{new} may be the new QP value corresponding to FVᵢ after re-adjustment;
QP₀^{org} may be the initial QP at FV₀ applied for encoding the frames by video encoder;
Bᵢ may be the blurriness level corresponding to FVᵢ during the refocusing process; and
a may be a constant parameter selected in a range defined as appropriate for the system design, and used to normalize the change in QP, such that QP^{new} remains in a set range, which may be standard-dependent. For example, in H.264, the range for QP values is [0,51]. In one example a may be in the range [0,10], and 10 may be the default value. The value of a may be selected by the user based on how much bit reduction the user desires to implement for blurry frames.

In one example, QP readjustment may be applied during the refocusing process. When refocusing is complete, the QP may be reset to the original QP value QP₀^{org}. In one example, during refocusing, each new QP value may be computed independently from the previously-computed QP value.

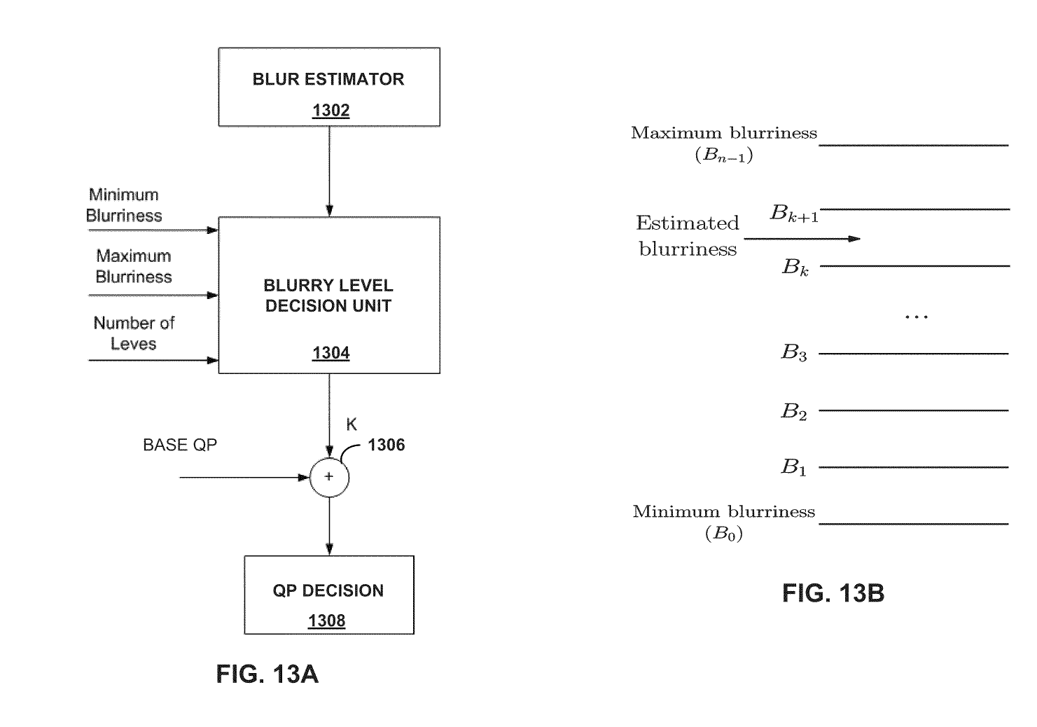

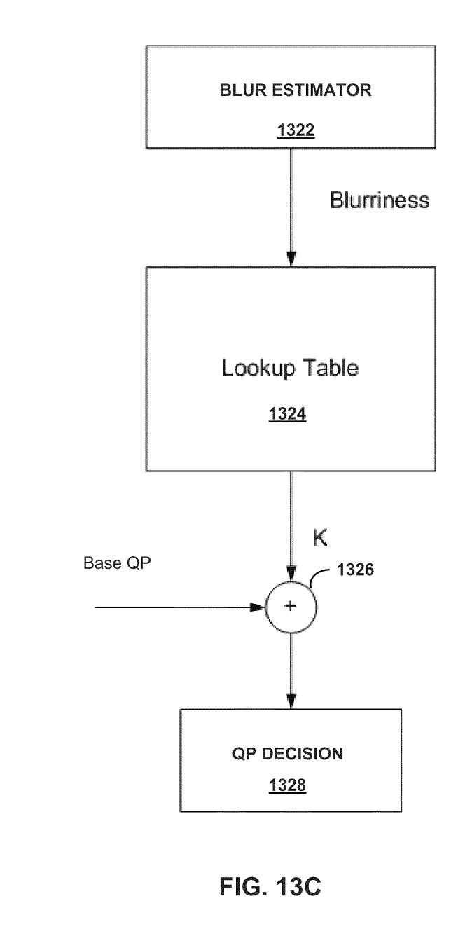

In another example, an estimated blurriness level may be determined for the estimated blurriness of the frame. FIG. 13A illustrates an example of a QP decision using blurriness levels. As FIG. 13B shows, n blurriness levels may be defined, based on a minimum blurriness B₀ and a maximum blurriness Bₙ₋₁. Referring to FIG. 13A, blurriness of a frame may be estimated by blurriness estimator 1302, which may be part of a blurriness unit (e.g., blurriness unit 108 or 208). The estimated blurriness may be then sent to blurry level decision unit 1304, which may be also part of the blurriness unit. Blurry level decision unit 1304 determine the blurriness level using the minimum blurriness, the maximum blurriness, and the number of levels of blurriness (see FIG. 13B). In one example, the minimum blurriness, maximum blurriness, and number of levels of blurriness may be device-specific and may be determined based on experimental result, as noted above. Blurry level decision unit 1304 may determine the range in which the estimated blurriness falls to determine the corresponding blurriness level, k. As FIG. 13B shows, the estimated blurriness of the frame may fall between Bₖ and Bₖ₊₁, and the estimated blurriness level may be k. The estimated blurriness level may then be added by adder 1306 to a QP_{base}, then compared to the maximum QP to determine the adjusted QP value in QP decision block 1308. This process may be summed by the following:

QP=min(QP_{base}+k,QPₘₐₓ)

where k is the level associated with the estimated blurriness of the frame, and QP_{base} is an average QP of N previous non-blurry frames, e.g., frames with no detected blurriness, and QPₘₐₓ is the maximum QP value associated with the codec, e.g., in H.264 QPₘₐₓ is 51. In one example, N may be 4.

In another example, the range of estimated blurriness and corresponding blurriness levels may be determined in advance and stored in a lookup table. FIG. 13C illustrates an example of a QP decision using a lookup table. In this example, blur estimator 1322 may estimate the blurriness of a frame. The estimated blurriness level k may be determined using the estimated blurriness and lookup table 1324. The estimated blurriness level may then be added by adder 1326 to a QP_{base}, then compared to the maximum QP to determine the adjusted QP value in QP decision block 1328.

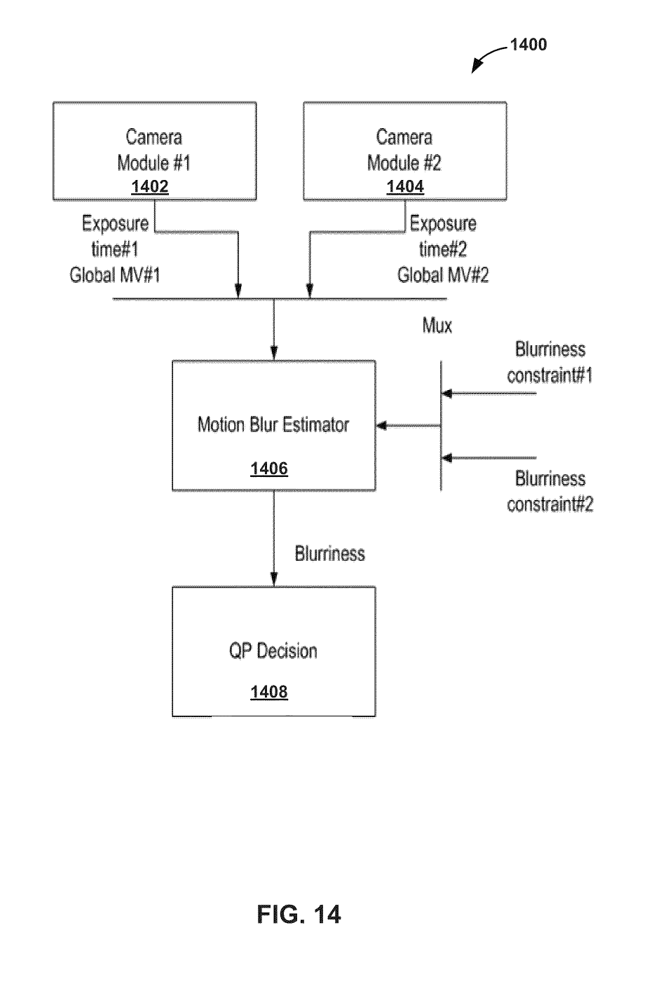

FIG. 14 illustrates an example system with two video capture device modules that implements the techniques of this disclosure. In this example, a system 1400 may comprise two camera modules 1402 and 1404, which may be video capture device modules similar to video capture devices 102 and 202, for example. Each of camera modules 1402 and 1404 may have different characteristics, and may capture frames of video data at different settings. Each of camera modules 1402 and 1404 may provide parameters associated with captured frames, e.g., global MVs, exposure time, and the like, as discussed above. The output captured frames from camera module 1402 and 1404 may be sent to a video encoding device (e.g., video encoder 110, 210, or 510), which may include, among other components, motion blur estimator 1406 and QP decision block 1408. Motion blur estimator 1406 may be part of a blurriness unit (e.g., blurriness unit 108 or 208). QP decision block 1408 may be part of a QP readjustment unit (e.g., QP readjustment unit 112 or 212).

Based on the source of the captured video frames, e.g., camera module 1402 or camera module 1404, the appropriate blurriness constraint may be selected. For example, blurriness constraint 1 may be associated with camera module 1402 and blurriness constraint 2 may be associated with camera module 1404. A blurriness constraint may indicate, for example, the minimum blurriness, maximum blurriness, and number of levels of blurriness associated with the corresponding camera module. When motion is detected in captured vide frame and blurriness is to be estimated in the frame, motion blur estimator 1406 may estimate the blurriness in the frames using the selected blurriness constraint. QP decision block 1408 may then utilize the estimated blurriness to determine the appropriate QP for encoding the frame, as described above. In this manner, the techniques of this disclosure may be utilized with different camera modules.

In one example, aspects of the disclosure may be used with an H.264 video encoding system. H.264 video encoding has achieved a significant improvement in compression performance and rate-distortion efficiency relative to existing standards. However, the computational complexity may be enhanced due to certain aspects of the encoding, such as, for example, the motion compensation process. H.264 supports motion compensation blocks ranging from 16×16 to 4×4. The rate distortion cost may be computed for each of the possible block partition combinations. The block partition that may result in the smallest rate distortion performance may be selected as the block partition decision. In the motion compensation process, the reference frames may be as many as 16 previously encoded frames, which may also increase the computational complexity of a system. In H.264 video encoding, prediction as small as ¼ or ⅛ sub-pixel prediction may be used, and interpolation methods may be used to compute the sub-pixel values.

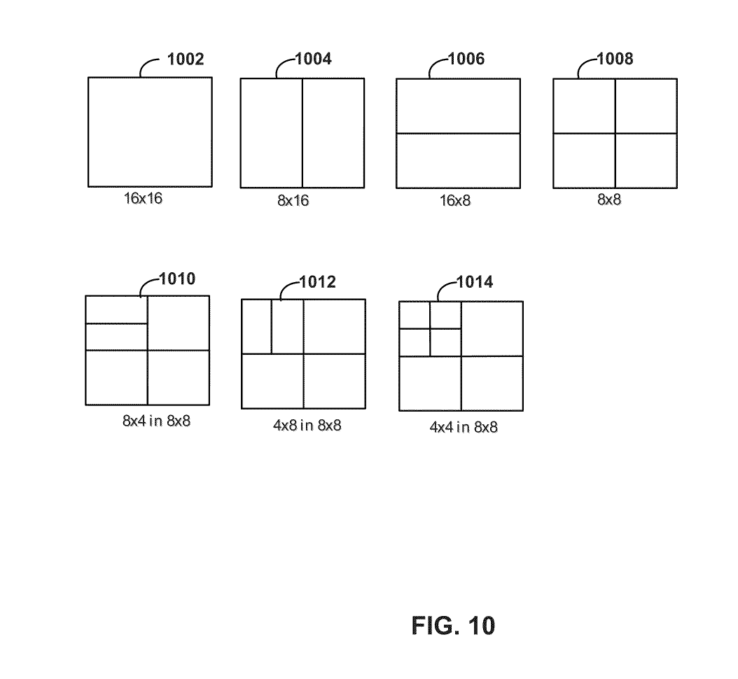

As discussed above, in H.264 video encoding, block partitions may range from 16×16 (1002) to 4×4 (1014), in any combination, as illustrated in FIG. 10. For example, once 8×8 (1008) block partition is selected, each 8×8 block may have partition choice of 8×4 (1010), 4×8 (1012), or 4×4 (1014).

In one example, the video encoding algorithm of a video encoder may be simplified based on the blurriness level. The blurriness level may be estimated using at least one of the methods described above. The estimated blurriness level may be compared to a predefined block partition threshold value:

Bᵢ≧Threshold_{BlockPartition}

Where Bi is the estimated blurriness level of frame i, and Threshold_blockpartition is a threshold value based on which the block partition level may be adjusted. The threshold value may be adjusted to be a value within a range, e.g., [0,1], according to a user's preference or the system requirements, for example. The higher the threshold value, the higher the blurriness level required to trigger simplification of the encoding algorithm.

In one example, if the estimated blurriness level exceeds the threshold value, video encoder 510 (FIG. 5) may select a larger block partition, e.g., 16×16 (1002), 16×8 (1006), 8×16 (1004), and 8×8 (1008), therefore decreasing the amount of motion compensation the video encoder needs to encode for a given frame or group of frames. The use of larger block partitions means that each frame is divided into larger blocks, and therefore, a smaller number of blocks per frame the video encoder will encode. As a result, the video encoder will encode less motion vectors, and will as a result use less system resources, e.g., power and memory. In one example, the video encoder may select a block partition based on the severity of blurriness in a frame. For example, larger block partition, e.g., 16×16, 16×8, or 8×16, may be used for frames with a high level of blurriness, and a slightly smaller block partition, e.g., 8×8, may be used for frames with a lower level of blurriness. If the blurriness level exceeds the threshold, the smaller block partitions, e.g., 8×4, 4×8, and 4×4, may be eliminated from consideration, and based on the severity of the blurriness, one of the larger block partitions may be selected as described above.

In another example, the encoding algorithm simplification may be achieved by limiting the range of frames from which the video encoder 510 selects a reference frame. Using a threshold value associated with reference frame selection, the video encoder 510 may narrow down reference frame choices to only the previous encoded frame:

Bᵢ≧Threshold_{Reference}

Where Bi is the estimated blurriness level of frame i, and Threshold reference is a threshold value based on which the reference picture list may be adjusted. In video encoding, when encoding a frame, a reference frame may be selected from a reference picture list for motion estimation purposes. The video encoder may determine the most appropriate reference frame, and search it to a current frame to encode motion estimation data. In one example, if the estimated blurriness level in a frame exceeds a threshold, the video encoder may limit the reference picture list to a subset of frames, such as, for example, the frame preceding the current blurry frame.

By utilizing blurriness estimation, the skip mode, e.g., in H.264, may be signaled when the blurriness level is higher than a pre-defined threshold. The selection activation of skip mode may also reduce the encoding data rate. Using a threshold value associated with the frame skip mode, the video encoder may determine to activate the skip mode:

Bᵢ≧Threshold_{FrameSkip}

Where Bi is the estimated blurriness level of frame i, and Threshold_frameskip is a threshold value based on which the frame skip mode may be activated. In one example, if the estimated blurriness level exceeds threshold for frame skip mode, the video encoder may activate skip mode, and the frame may be skipped (i.e., discarded) without encoding. In one example, the threshold for frame skip may be larger than the threshold for other encoding algorithm simplification techniques, e.g., pixel precision level, block partition level, and reference picture list modification. In one example, the estimated blurriness level for a frame may be first compared to the frame skip threshold, such that, if the blurriness level exceeds the threshold, and the frame is to be skipped, the video capture device need not perform the other comparisons to thresholds, as the video encoder need not encode anything associated with the frame. In one example, comparison of the estimated blurriness level to the various thresholds may be performed in a specific order, based on the order of progression of the simplification algorithms. For example, modification of the reference picture list may be performed prior to partition block level and pixel precision level determinations.

In another example, blurriness estimation during refocusing may be used to signal the frames that may have blurry content so that the video encoder implements and applies a de-blurring algorithm to these frames. The video encoder may not have to make the determination that the frame is blurry, and just apply the de-blurring algorithm when it receives a signal from the video capture device indicating presence of blurry content. In another example, the estimated blurriness level may be used to determine the amount of de-blurring needed for a blurry frame, where based on the level of blurriness, the video encoder selects a corresponding de-blurring algorithm, or defines corresponding parameters used by the de-blurring algorithm. In this manner, the video encoder may apply different de-blurring levels according to the level of blurriness in the frame.

In accordance with this disclosure, the video encoder may include a blurriness unit that estimates an amount of blurriness in video frames using parameters and information from the video capture device. In some examples, the video encoder may not have access to refocusing statistics and other camera parameters (e.g., FV values, lens positions, global MV, exposure time, zoom, and the like), and may therefore, be incapable of determining the amount of blur in frames based on refocusing statistics. As a result, the video encoder may need to perform more computationally-intensive calculations to determine blurriness in frames. Using aspects of this disclosure, a video capture device may include a blurriness unit that estimates blurriness levels during refocusing and other functions and motions that cause blurriness, and sends the blurriness levels to video encoder. In the examples described herein, different strategies may be utilized to evaluate blurriness level during refocusing and in frames in which motion is detected. In one example, QP re-adjustment may be used in video encoding to better control and decrease video data rate based on the blurriness level during refocusing. In one example, video encoding algorithm simplification may be improved using estimated blurriness. In another example, a video capture device may estimate blurriness to identify blurry frames and their blurriness level caused by CAF refocusing. The video capture device may send the blurriness information to the video encoder, which may apply de-blurring techniques to de-blur frame content.

In an example of this disclosure, computation of the discussed algorithms may utilize less computing resources, resulting from several factors. For example, CAF statistics such as blurriness indicated by FV may have already been processed in the video capture device itself, as part of the AF process, and parameters such as global MV, zoom, and face detection parameters may be available with each captured frame. Therefore, little or no extra computation may be needed to compute, for example, lens positions and the focus values, in the encoder. Also, for example, blurriness level estimation may involve simple subtraction, division, and multiplication with a constant parameter for the computation. Furthermore, for example, computation of QP re-adjustment during CAF refocusing and other functions may be simple and straight forward without requiring too much additional computational complexity to the video encoder, or if done in the camera system, may reduce some computations from the encoder side. The techniques and methods described above may be useful in informing the video encoder of blurry frame content without causing delays with extra computations in the video encoder. Additionally, in certain circumstances, as discussed above, the computational complexity of motion compensation may be significantly reduced by identifying blurry frame content without causing delays, in addition to efficiently reducing the encoding data rate.

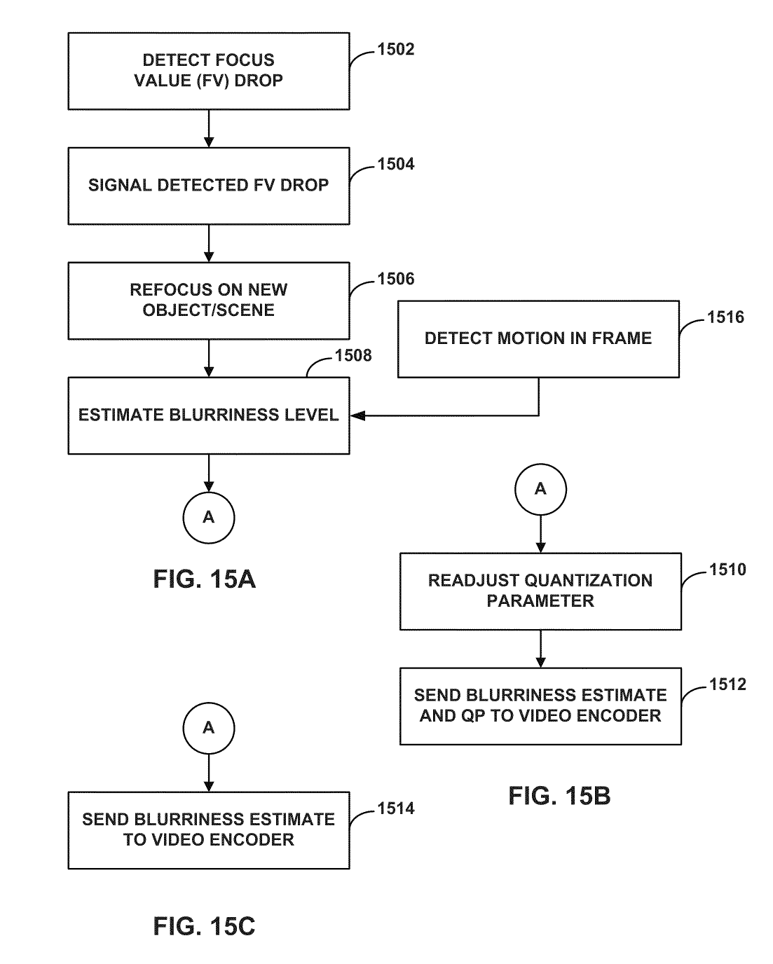

FIGS. 15A-15C are flow diagrams illustrating control of video encoding using estimate of blurriness levels in captured frames in accordance with example techniques of this disclosure. The process of FIG. 15 may be performed in a video system by a front-end device, e.g., a video capture device or video camera, and a back-end device, e.g., video encoder. Different aspects of the process of FIG. 15 may be allocated between the video capture device and the video encoder. For example, blurriness estimation and QP readjustment may be performed in the video encoder (FIG. 1) or the video capture device (FIG. 2).

In one example, As shown in FIG. 15, a video capture device 102 (FIG. 1) with CAF, may be capturing frames and sending them to a video encoder 110 (FIG. 1). The video capture device may determine based on a drop in the focus value of a captured frame that a change has occurred in the frame resulting in reduced focus (1502). The video capture device may have an input sensor unit 104 (FIG. 1) that captures the video frames, and determines when the focus value of the captured frame has dropped, therefore, indicating possible blurriness in the frame. The drop in focus may be caused by a new object coming into or moving out of or around the scene or new scene resulting from the user of the video capture device, either intentionally or unintentionally, redirecting the video capture device toward the new object or scene. The input sensor unit may determine based on the captured frame the FV of the frame, and compares it to the previous frame FV. When the FV drops, the input sensor unit may signal the detected drop to a CAF unit 106 (FIG. 1) within the video capture device (1504). In response to the indicated drop in FV, the CAF unit initiates a refocusing process (1506). The refocusing process may involve actions such as, for example, adjusting the lens position until the video capture device achieves a desired focus, e.g., as indicated by a peaking of the FV. While the video capture device is performing the refocusing process, the captured frames may be out of focus and may as a result be blurry. The video capture device may estimate the blurriness level in each frame captured during the refocusing process (1508).

In another example, the input sensor unit of the video capture device may detect motion in captured frames (1516). The motion may be the result of panning motion, zooming, other type of motion (moving closer and farther away from an object), or other types of motion. Based on the type of motion detected, the video capture device may perform autofocus (e.g., if a face is detected during a motion, or during zooming) or may capture the frames without performing focus (e.g., while moving during panning).

A blurriness unit 108 (FIG. 1) or 208 (FIG. 2), which may be part of the video capture device or the video encoder, may implement algorithms to estimate a frame's blurriness level, as described above. In the example of blurriness resulting from motion, whether or not autofocus is needed, the blurriness of the frame may be determined as discussed above, for each frame. The estimated blurriness may then be used to readjust the QP that the video encoder utilizes in its quantization functionality. The QP controls the degree of quantization applied to residual transform coefficient values produced by the encoder. When an encoder utilizes more quantization, a greater amount of image detail is retained. However, using more quantization results in a higher encoding data rate. As the quantization decreases, the video encoding rate drops, but some of the detail gets lost, and the image may become more distorted. In blurry images, details of the images are already distorted, and a video encoder may decrease quantization, without affecting the quality of the image. In accordance with this disclosure, the video capture device or the video encoder may readjust the QP to a larger value for frames captured during the refocusing process based on the amount of blurriness in the frames.

In one example of this disclosure, the blurriness unit and the QP readjustment may be part of the video capture device. In this example, the video capture device may send the adjusted QP to the video encoder to further reduce the amount of computations that the video encoder performs, as illustrated in FIG. 15B. In this example, based on the estimated blurriness level, the video capture device may readjust the QP value that the video encoder uses to encode a frame (1510). The video capture device may then communicate to the video encoder the readjusted QP value and the estimated blurriness level (1512). The video encoder then utilizes the readjusted QP value for quantization, and the estimated blurriness level to simplify several encoding algorithms, as described above.

In another example of this disclosure, the blurriness unit and the QP readjustment may be in the video encoder and may communicate the parameters associated with the frame to the video encoder (1514), as illustrated in FIG. 15C. In this example, the video encoder may estimate the blurriness, readjust the QP based on the estimated blurriness level, and utilize the readjusted QP for quantization. The video encoder may also utilize the estimated blurriness level to simplify several encoding algorithms, as described above.

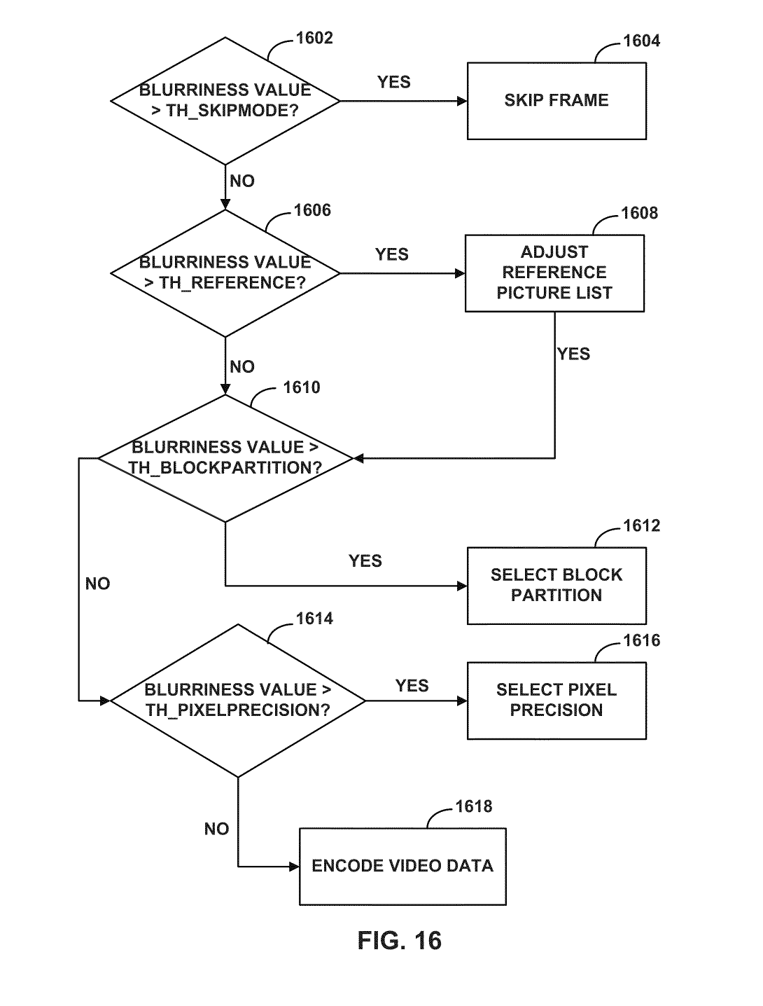

FIG. 16 is a flow diagram illustrating video encoding using the estimate of blurriness levels to simplify encoding algorithms in accordance with aspects of this disclosure. A blurriness unit, e.g., blurriness unit 108 of FIG. 1 or 208 of FIG. 2, may estimate a blurriness level of a captured frame as described above. The blurriness unit may provide the estimated blurriness level to a video encoder, e.g., video encoder 110 of FIG. 1 or 210 of FIG. 2, which may utilize the estimated blurriness level to simplify encoding algorithms. The video encoder may simplify encoding algorithms based on the level of blurriness in the frame, which the video encoder may determine based on comparison with thresholds associated with the different encoding algorithms. In one example, the video encoder may compare the estimated blurriness level to a threshold associated with frame skip mode (1602). If the estimated blurriness level exceeds the threshold for frame skip mode, the video encoder may activate skip mode (1604), and the frame may be skipped without encoding, because the video encoder operates on the assumption that the blurriness level is so high that a group of consecutive frames will look substantially identical. As a result, the video encoder may encode one of the blurry frames, and skip encoding the other substantially identical blurry frames. If the skip mode is activated, and the frame is therefore skipped, the frame may not be encoded, and therefore, the video encoder may not need to proceed in making decisions regarding the other encoding algorithm simplification.

If the estimated blurriness level does not exceed the threshold for frame skip mode, the video encoder does not activate the skip mode, and may proceed to determine whether to adjust the reference picture list. In one example, the video encoder may compare the estimated blurriness level to a threshold associated with the reference frame (1606). If the estimated blurriness level exceeds the threshold, the video encoder may limit the reference picture list to a subset of frames, such as, for example, the frame preceding the current blurry frame (1608) and may proceed to determine the block partition size for motion estimation. If the estimated blurriness level does not exceed the threshold, the video encoder may utilize the existing reference picture list, and proceed to determine the block partition size for motion estimation.

In one example, the video encoder may compare the estimated blurriness level to a threshold associated with the partition block (1610). If the estimated blurriness level exceeds the threshold, the video encoder may utilize a larger block partition for encoding motion estimation (1612). For example, in H.264 encoding utilizes block partitions in sizes of 16×16, 8×16, 16×8, 8×8, 4×8, 8×4, and 4×4. For blurry frames, the video encoder may implement motion estimation utilizing larger partitions, e.g., 16×16, 8×16, and 16×8, therefore, requiring encoding of less motion pictures. The video encoder may proceed to determine the pixel precision for motion estimation. If the estimated blurriness level does not exceed the threshold, the video encoder may utilize the block partition according to its usual implementation, and proceed to determine the pixel precision for motion estimation. In one example, when a frame contains blurry content, the level of the blurriness may be determined and based on the severity of blurriness, a block partition may be determined accordingly, where larger partition blocks may be utilized for a greater amount of blurriness.

In one example, the video encoder may compare the estimated blurriness level to a threshold associated with pixel precision used in motion estimation (1614). If the estimated blurriness level exceeds the threshold, the video encoder may adjust the pixel precision for implementing motion estimation (1616), where a larger pixel precision may be used for blurry images, thus requiring fewer computations. In one example, the video encoder may utilize integer pixel precision, thus eliminating the need for sub-pixel interpolation in searching for reference blocks used in motion estimation. In another example, the video encoder may assess the severity of blurriness in a frame, and adjust the pixel precision accordingly. For example, the video encoder may utilize integer pixel precision for frames with a large amount of blurriness, but a relatively larger sub-pixel precision, e.g., ½, for frames with a smaller level of blurriness. If the estimated blurriness level does not exceed the threshold, the video encoder may encode the frame in the same manner the video encoder encodes frames with no blurriness (1618). In one example, the video encoder may encode the video data according to proprietary encoding method associated with the video encoder or according to a video standard such as H.264 or HEVC, for example.

The video encoder may utilize the modified encoding techniques for encoding frames captured during the refocus process, and may revert back to its normal encoding functionality for frames captured while the video capture device is in focus. In one example, the video encoder may use different levels of modifications for encoding algorithms and functionalities depending on the severity of the blur in the captured frames. For example, a higher level of blurriness may result in readjusting the QP to a larger value than that associated with a lesser level of blurriness. In one example, the video encoder may also utilize blurriness information received from the video capture device to implement de-blurring functions.

The front end, e.g., video capture device, and the back end, e.g., video encoder, portions of the system may be connected directly or indirectly. In one example, the video capture device may be directly connected to the video encoder, for example, using some type of a wired connection. In another example, the camcorder may be indirectly connected to the video encoder, for example, using a wireless connection.

The techniques described in this disclosure may be utilized in a device to assist in the functionalities of a video encoder, or may be utilized separately as required by the device and the applications for which the device may be used.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware, firmware, and/or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause one or more programmable processors, or other processors, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

In an exemplary implementation, techniques described in this disclosure may be performed by a digital video coding hardware apparatus, whether implemented in part by hardware, firmware and/or software.

Various aspects and examples have been described. However, modifications can be made to the structure or techniques of this disclosure without departing from the scope of the following claims.

1. A method comprising:
estimating a blurriness level of a frame of video data based on a type of motion detected in the frame; and
encoding, in a video encoder, the frame based at least in part on the estimated blurriness level of the frame.

2. The method of claim 1, wherein encoding comprises selecting a level of quantization to be used for encoding the frame based on the estimated blurriness level.

3. The method of claim 1, further comprising determining whether to estimate the blurriness level of the frame based on the type of motion detected.

4. The method of claim 1, wherein the frame of video data is captured by a video capture module.

5. The method of claim 1, wherein detecting the motion comprises determining a global motion vector associated with the frame of video data.

6. The method of claim 5, further comprising:
comparing the global motion vector to a global motion vector threshold;
estimating the blurriness level when the global motion vector exceeds the global motion vector threshold; and
encoding the frame without estimating the blurriness level when the global motion vector is equal to or less than the global motion vector threshold.

7. The method of claim 6, further comprising:
determining a local motion vector associated with the frame;
comparing the local motion vector to a local motion vector threshold;
estimating the blurriness level when the global motion vector exceeds the global motion vector threshold and the local motion vector exceeds the local motion vector threshold; and
encoding the frame without estimating the blurriness level when the global motion vector is equal to or less than the global motion vector threshold or the local motion vector is equal to or less than the local motion vector threshold.

8. The method of claim 5, wherein estimating the blurriness level comprises estimating the blurriness level based on the global motion vector and one or more parameters associated with the video capture module.

9. The method of claim 8, wherein the parameters associated with the video capture device comprise time exposure and frame rate.

10. The method of claim 1, further comprising:
detecting the motion by detecting change in optical zooming by a zoom factor associated with the frame; and
estimating the blurriness level based on the zoom factor.

11. The method of claim 1, further comprising:
detecting the motion by detecting panning motion associated with the video capture module; and
estimating the blurriness level based on a focus value associated with the frame, when the frame is captured after the panning motion.

12. The method of claim 1, further comprising:
detecting the motion by detecting a face in the frame; and
estimating the blurriness level based on a size of the detected face in the frame.

13. An apparatus comprising:
a blurriness unit configured to estimate a blurriness level of a frame of video data based on a type of motion detected in the frame; and
a video encoder configured to encode the frame based at least in part on the estimated blurriness level of the frame.

14. The apparatus of claim 13, wherein to encode the frame, the video encoder selects a level of quantization to be used for encoding the frame based on the estimated blurriness level.

15. The apparatus of claim 13, wherein the blurriness unit is further configured to determine whether to estimate the blurriness level of the frame based on the type of motion detected.

16. The apparatus of claim 13, further comprising a video capture module configured to capture the frame of video data.

17. The apparatus of claim 13, wherein to detect the motion, the video capture device is further configured to detect a global motion vector associated with the frame of video data.

18. The apparatus of claim 17, wherein the blurriness unit is further configured to:
compare the global motion vector to a global motion vector threshold; and
estimate the blurriness level when the global motion vector exceeds the global motion vector threshold,
wherein the video encoder is further configured to encode the frame without estimating the blurriness level when the global motion vector is equal to or less than the global motion vector threshold.

19. The apparatus of claim 18, wherein the video encoder is further configured to determine a local motion vector associated with the frame, the blurriness unit is further configured to compare the local motion vector to a local motion vector threshold and estimate the blurriness level when the global motion vector exceeds the global motion vector threshold and the local motion vector exceeds the local motion vector threshold, and the video encoder is further configured to encode the frame without estimating the blurriness level when the global motion vector is equal to or less than the global motion vector threshold or the local motion vector is equal to or less than the local motion vector threshold.

20. The apparatus of claim 17, wherein the blurriness unit is configured to estimate the blurriness level based on the global motion vector and one or more parameters associated with the video capture device.

21. The apparatus of claim 20, wherein the parameters associated with the video capture device comprise time exposure and frame rate.

22. The apparatus of claim 13, further comprising:
a video capture module configured to detect the motion by detecting change in optical zooming by a zoom factor associated with the frame; and
a blurriness unit configured to estimate the blurriness level based on the zoom factor.

23. The apparatus of claim 13, further comprising:
a video capture module configured to detect the motion by detecting panning motion associated with the video capture module; and
a blurriness unit configured to estimate the blurriness level based on a focus value associated with the frame, when the frame is captured after the panning motion.

24. The apparatus of claim 13, further comprising:
a video capture module configured to detect the motion by detecting a face in the frame; and
a blurriness unit configured to estimate the blurriness level based on a size of the detected face in the frame.

25. A computer-readable medium comprising instructions for causing a programmable processor to:
estimate a blurriness level of a frame of video data based on a type of motion detected in the frame; and
encode, in a video encoder, the frame based at least in part on the estimated blurriness level of the frame.

26. The computer-readable medium of claim 25, wherein the instructions to encode comprise instruction that cause the processor to select a level of quantization to be used for encoding the frame based on the estimated blurriness level.

27. The computer-readable medium of claim 25, further comprising instructions that cause the processor to determine whether to estimate the blurriness level of the frame based on the type of motion detected.

28. The computer-readable medium of claim 25, wherein the instructions to detect the motion comprise instructions that cause the processor to detect a global motion vector associated with the frame of video data.

29. The computer-readable medium of claim 28, further comprising instructions that causes the processor to:
compare the global motion vector to a global motion vector threshold;
estimate the blurriness level when the global motion vector exceeds the global motion vector threshold; and
encode the frame without estimating the blurriness level when the global motion vector is equal to or less than the global motion vector threshold.

30. The computer-readable medium of claim 29, further comprising instructions that cause the process to:
determine a local motion vector associated with the frame;
compare the local motion vector to a local motion vector threshold;
estimate the blurriness level the global motion vector exceeds the global motion vector threshold and the local motion vector exceeds the local motion vector threshold; and
encode the frame without estimating the blurriness level when the global motion vector is equal to or less than the global motion vector threshold or the local motion vector is equal to or less than the local motion vector threshold.

31. The computer-readable medium of claim 28, wherein the instructions to estimate the blurriness level comprise instructions that cause the processor to estimate the blurriness level based on the global motion vector and one or more parameters associated with the video capture device.

32. The computer-readable medium of claim 31, wherein the parameters associated with the video capture device comprise time exposure and frame rate.

33. The computer-readable medium of claim 25, further comprising instructions that cause the processor to:
detect the motion by detecting change in optical zooming by a zoom factor associated with the frame; and
estimate the blurriness level based on the zoom factor.

34. The computer-readable medium of claim 25, further comprising instructions that cause the processor to:
detect the motion by detecting panning motion associated with the video capture module; and
estimate the blurriness level based on a focus value associated with the frame, when the frame is captured after the panning motion.

35. The computer-readable medium of claim 25, further comprising instructions that cause the processor to:
detect the motion by detecting a face in the frame; and
estimate the blurriness level based on a size of the detected face in the frame.

36. A system comprising:
means for estimating a blurriness level of a frame of video data based on a type of motion detected in the frame; and
means for encoding, the frame based at least in part on the determination whether to estimate the blurriness level of the frame.

37. The system of claim 36, wherein the means for encoding comprise means for selecting a level of quantization to be used for encoding the frame based on the estimated blurriness level.

38. The system of claim 36, further comprising means for determining whether to estimate the blurriness level of the frame based on the type of motion detected.

39. The system of claim 36, wherein the frame of video data is captured by a video capture module.

40. The system of claim 36, wherein the means for detecting the motion comprises means for detecting a global motion vector associated with the frame of video data.

41. The system of claim 40, further comprising:
means for comparing the global motion vector to a global motion vector threshold;
means for estimating the blurriness level when the global motion vector exceeds the global motion vector threshold; and
means for encoding the frame without estimating the blurriness level when the global motion vector is equal to or less than the global motion vector threshold.

42. The system of claim 41, further comprising:
means for determining a local motion vector associated with the frame;
means for comparing the local motion vector to a local motion vector threshold;
means for estimating the blurriness level the global motion vector exceeds the global motion vector threshold and the local motion vector exceeds the local motion vector threshold; and
means for encoding the frame without estimating the blurriness level when the global motion vector is equal to or less than the global motion vector threshold or the local motion vector is equal to or less than the local motion vector threshold.

43. The system of claim 40, wherein the means for estimating the blurriness level comprises means for estimating the blurriness level based on the global motion vector and one or more parameters associated with the video capture device.

44. The system of claim 43, wherein the parameters associated with the video capture device comprise time exposure and frame rate.

45. The system of claim 36, further comprising:
means for detecting the motion by detecting change in optical zooming by a zoom factor associated with the frame; and
means for estimating the blurriness level based on the zoom factor.

46. The system of claim 36, further comprising:
means for detecting the motion by detecting panning motion associated with the video capture module; and
means for estimating the blurriness level based on a focus value associated with the frame, when the frame is captured after the panning motion.

47. The system of claim 36, further comprising:
means for detecting the motion by detecting a face in the frame; and
means for estimating the blurriness level based on a size of the detected face in the frame.
